(19) United States
(12) Patent Application Publication
(10) Pub. No.: US 2022/0277491 A1
(43) Pub. Date: Sep. 1, 2022

(54) METHOD AND DEVICE FOR MACHINE LEARNING-BASED IMAGE COMPRESSION USING GLOBAL CONTEXT

(71) Applicant: Electronics and Telecommunications Research Institute, Daejeon (KR)

(72) Inventors: Joo-Young LEE, Daejeon (KR); Seung-Hyun CHO, Daejeon (KR); Hyunsuk KO, Daejeon (KR); Hyoung-Jin KWON, Daejeon (KR); Youn-Hee KIM, Daejeon (KR); Jong-Ho KIM, Daejeon (KR); Se-Yoon JEONG, Daejeon (KR); Hui-Yong KIM, Daejeon (KR); Jin-Soo CHOI, Daejeon (KR)

(73) Assignee: Electronics and Telecommunications Research Institute, Daejeon (KR)

(21) Appl. No.: 17/615,519

(22) PCT Filed: May 29, 2020
(86) PCT No.: PCT/KR2020/007039

§ 371 Date: Nov. 30, 2021

(30) Foreign Application Priority Data
May 31, 2019 (KR) 10-2019-0064882
May 29, 2020 (KR) 10-2020-0065289

(51) Int. Cl. G06T 9/00; G06T 3/40

(52) U.S. Cl. CPC G06T 9/002; G06T 3/4046; G06T 3/4023

(57) ABSTRACT

Disclosed herein are a method and apparatus for image compression based on machine learning using a global context. The disclosed image compression network employs an existing image quality enhancement network for an end-to-end joint learning scheme. The image compression network may jointly optimize image compression enhancement and quality enhancement. The image compression networks and image quality enhancement networks may be easily combined within a unified architecture which minimizes total loss, and may be easily jointly optimized.

### TECHNICAL FIELD

The following embodiments relate to a video decoding method and apparatus and a video encoding method and apparatus, and more particularly to a decoding method and apparatus and an encoding method and apparatus which provide image compression based on machine learning using a global context.

This application claims the benefit of Korean Patent Application No. 10-2019-0064882, filed May 31, 2019, which is hereby incorporated by reference in its entirety into this application.

This application claims the benefit of Korean Patent Application No. 10-2020-0065289, filed May 29, 2020, which is hereby incorporated by reference in its entirety into this application.

### BACKGROUND ART

Recently, research on learned image compression methods has been actively conducted. Among these learned image compression methods, entropy-minimization-based approaches have achieved superior results compared to typical image codecs such as Better Portable Graphics (BPG) and Joint Photographic Experts Group (JPEG) 2000.

However, quality enhancement and rate minimization are coupled to be conflictive in the process of image compression. That is, maintaining high image quality entails less compressibility and vice versa.

However, by jointly training separate quality enhancement in conjunction with image compression, coding efficiency can be improved.

### DISCLOSURE

### Technical Problem

An embodiment is intended to provide an encoding apparatus and method and a decoding apparatus and method which provide image compression based on machine learning using a global context.

### Technical Solution

In accordance with an aspect, there is provided an encoding method, including generating a bitstream by performing entropy encoding that uses an entropy model on an input image; and transmitting or storing the bitstream.

The entropy model may be a context-adaptive entropy model.

The context-adaptive entropy model may exploit three different types of contexts.

The contexts may be used to estimate parameters of a Gaussian mixture model.

The parameters may include a weight parameter, a mean parameter, and a standard deviation parameter.

The entropy model may be a context-adaptive entropy model.

The context-adaptive entropy model may use a global context.

The entropy encoding may be performed by combining an image compression network with a quality enhancement network.

The quality enhancement network may be a very deep super resolution network (VDSR), a residual dense network (RDN) or a grouped residual dense Network (GRDN).

Horizontal padding or vertical padding may be applied to the input image.

The horizontal padding may be to insert one or more rows into the input image at a center of a vertical axis thereof.

The vertical padding may be to insert one or more columns into the input image at a center of a horizontal axis thereof.

The horizontal padding may be performed when a height of the input image is not a multiple of k.

The vertical padding may be performed when a width of the input image is not a multiple of k.

k may be 2ⁿ.

n may be a number of down-scaling operations performed on the input image.

There may be provided a storage medium storing the bitstream generated by the encoding method.

In accordance with another aspect, there is provided a decoding apparatus, including a communication unit for acquiring a bitstream; and a processing unit for generating a reconstructed image by performing decoding that uses an entropy model on the bitstream.

In accordance with a further aspect, there is provided a decoding method, including acquiring a bitstream; and generating a reconstructed image by performing decoding that uses an entropy model on the bitstream.

The entropy model may be a context-adaptive entropy model.

The context-adaptive entropy model may exploit three different types of contexts.

The contexts may be used to estimate parameters of a Gaussian mixture model.

The parameters may include a weight parameter, a mean parameter, and a standard deviation parameter.

The entropy model may be a context-adaptive entropy model.

The context-adaptive entropy model may use a global context.

The entropy encoding may be performed by combining an image compression network with a quality enhancement network.

The quality enhancement network may be a very deep super resolution network (VDSR), a residual dense network (RDN) or a grouped residual dense Network (GRDN).

A horizontal padding area or a vertical padding area may be removed from the reconstructed image.

Removal of the horizontal padding area may be to remove one or more rows from the reconstructed image at a center of a vertical axis thereof.

Removal of the vertical padding area may be to remove one or more columns from the reconstructed image at a center of a horizontal axis thereof.

The removal of the horizontal padding area may be performed when a height of an original image is not a multiple of k.

The removal of the vertical padding area may be performed when a width of the original image is not a multiple of k.

k may be 2ⁿ.

n may be a number of down-scaling operations performed on the original image.

### Advantageous Effects

There are provided an encoding apparatus and method and a decoding apparatus and method which provide image compression based on machine learning using a global context.

### DESCRIPTION OF DRAWINGS

FIG. 1 illustrates end-to-end image compression based on an entropy model according to an example;

FIG. 2 illustrates extension to an autoregressive approach according to an example;

FIG. 3 illustrates the implementation of an autoencoder according to an embodiment;

FIG. 4 illustrates trainable variables tier an image according to an example;

FIG. 5 illustrates derivation using clipped relative positions;

FIG. 6 illustrates offsets for a current position (0, 0) according to an example;

FIG. 7 illustrates offsets for a current position (2, 3) according to an example;

FIG. 8 illustrates an end-to-end joint learning scheme for image compression and quality improvement combined in a cascading manner according to an embodiment;

FIG. 9 illustrates the overall network architecture of an image compression network according to an embodiment;

FIG. 10 illustrates the structure of a model parameter estimator according to an example;

FIG. 11 illustrates a non-local context processing network according to an example;

FIG. 12 illustrates an offset-context processing network according to an example;

FIG. 13 illustrates variables mapped to a global context region according to an example;

FIG. 14 illustrates the architecture of a GRDN according to an embodiment;

FIG. 15 illustrates the architecture of a GRDB of the GRDN according to an embodiment;

FIG. 16 illustrates the architecture of an RDB of the GRDB according to an embodiment;

FIG. 17 illustrates an encoder according to an embodiment;

FIG. 18 illustrates a decoder according to an embodiment;

FIG. 19 is a configuration diagram of an encoding apparatus according to an embodiment;

FIG. 20 is a configuration diagram of a decoding apparatus according to an embodiment;

FIG. 21 is a flowchart of an encoding method according to an embodiment;

FIG. 22 is a flowchart of a decoding method according to an embodiment;

FIG. 23 illustrates padding to an input image according to an example;

FIG. 24 illustrates code for padding in encoding according to an embodiment;

FIG. 25 is a flowchart of a padding method in encoding according to an embodiment;

FIG. 26 illustrates code for removing a padding area in encoding according to an embodiment; and

FIG. 26 is a flowchart of a padding removal method in encoding according to an embodiment.

### MODE FOR INVENTION

Descriptions of the following exemplary embodiments refer to the attached drawings in which specific embodiments are illustrated by way of example. These embodiments are described in detail so that those having ordinary knowledge in the technical field to which the present disclosure pertains can easily practice the present disclosure. It is to be understood that the various embodiments, although different, are not necessarily mutually exclusive. For example, a particular feature, structure, or characteristic described in one embodiment may be included within other embodiments without departing from the spirit and scope of the present disclosure. Further, it is to be understood that locations or arrangement of individual elements in each disclosed embodiment may be changed without departing from the spirit and scope of the present disclosure. Therefore, the accompanying detailed descriptions are not intended to take the present disclosure in a restrictive sense, and the scope of the exemplary embodiments should be defined by the accompanying claims and equivalents thereof as long as they are appropriately described.

In the drawings, the similar reference numerals are used to designate the same or similar functions from various aspects. Accordingly, the shapes, sizes, etc. of components in the drawings may be exaggerated to make the description clearer.

The terms used in the present specification are merely used to describe specific embodiments and are not intended to limit the present disclosure. In embodiments, a singular expression includes a plural expression unless a description to the contrary is specifically pointed out in context. In the present specification, it should be understood that the terms “comprise” and/or “comprising” are merely intended to indicate that the described component, step, operation, and/or device are present, and are not intended to exclude a possibility that one or more other components, steps, operations, and/or devices will be included or added, and that the additional configuration may be included in the scope of the implementation of exemplary embodiments or the technical spirit of the exemplary embodiments. It should be understood that in this specification, when it is described that a component is “connected” or “coupled” to another component, the two components may be directly connected or coupled, but additional components may be interposed therebetween.

It will be understood that, although the terms “first” and “second” may be used herein to describe various elements, these elements are not limited by these terms. These terms are only used to distinguish one element from other elements. For instance, a first element discussed below could be termed a second element without departing from the scope of the disclosure. Similarly, the second element can also be termed the first element.

Further, components described in embodiments are independently illustrated to indicate different characteristic functions, and it does not mean that each component is implemented as only a separate hardware component or software component. That is, each component is arranged as a separate component for convenience of description. For example, among the components, at least two components may be integrated into a single component. Further, a single component may be separated into multiple components. Such embodiments in which components are integrated or in which each component is separated may also be included in the scope of the present disclosure without departing from the essentials thereof.

Further, some components may be selective components only for improving performance rather than essential components for performing fundamental functions. Embodiments may be implemented to include only essential components necessary for the implementation of the essence of the embodiments, and structures from which selective components such as those used only to improve performance are excluded may also be included in the scope of the present disclosure.

Hereinafter, in order for those skilled in the art to easily implement embodiments, embodiments will be described in detail with reference to the attached drawings, in the description of the embodiments, repeated descriptions and descriptions of known functions and configurations which have been deemed to unnecessarily obscure the gist of the present invention will be omitted below.

In the description of the specification, the symbol “/” may be used as an abbreviation of “and/or”. In other words, “A/B” may mean “A and/or B” or “at least one of A and B”.

### Image Compression Based on Machine Learning Using Global Context

Recently, considerable development of artificial neural networks has led to many groundbreaking achievements in various research fields. In image and video compression fields, a lot of learning-based research has been conducted.

In particular, some latest end-to-end optimized image compression approaches based on entropy minimization have already exhibited better compression performance than those of existing image compression codecs such as BPG and JPEG2000.

Despite the short history of the field, the basic approach to entropy minimization is to train an analysis transform network (i.e., an encoder) and a synthesis transform network, thus allowing those networks to reduce the entropy of transformed latent representations while keeping the quality of reconstructed images as close to the originals as possible.

Entropy minimization approaches can be viewed from two different aspects, that is, prior probability modeling and context exploitation.

Prior probability modeling is a main element of entropy minimization, and allows an entropy model to approximate the actual entropy of latent representations. Prior probability modeling may play a key role for both training and actual entropy decoding and/or encoding.

For each transformed representation, an image compression method estimates the parameters of the prior probability model based on contexts such as previously decoded neighbor representations or some pieces of bit-allocated side information.

Better contexts can be regarded as the information given to a model parameter estimator. This information may be helpful in more precisely predicting the distributions of latent representations.

### Artificial Neural Network (ANN)-Based Image Compression

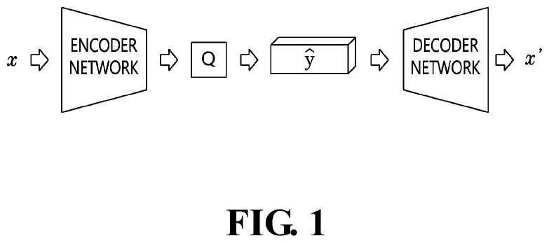

FIG. 1 illustrates end-to-end image compression based on an entropy model according to an example.

Methods proposed in relation to ANN-based image compression may be divided into two streams.

First, as a consequence of the success of generative models, some image compression approaches for targeting superior perceptual quality have been proposed.

The basic idea of these approaches is that learning the distribution of natural images enables the implementation of a very high compression level without severe perceptual loss by allowing the generation of image components, such as texture, which do not highly affect the structure or the perceptual quality of reconstructed images.

However, although the images generated by these approaches are very realistic, the acceptability of machine-created image components may eventually become somewhat application-dependent.

Second, some end-to-end optimized ANN-based approaches without using generative models may be used.

In these approaches, unlike traditional codecs including separate tools, such as prediction, transform, and quantization, a comprehensive solution covering all functions may be provided through the use of end-to-end optimization.

For example, one approach may exploit a small number of latent binary representations to contain compressed information in all steps. Each step may increasingly stack additional latent representations to achieve a progressive improvement in the quality of reconstructed images.

Other approaches may improve compression performance by enhancing a network structure in the above-described approaches.

These approaches may provide novel frameworks suitable for quality control over a single trained network. In these approaches, an increase in the number of iteration steps may be a burden on several applications.

These approaches may extract binary representations having as high entropy as possible. In contrast, other approaches may regard an image compression problem as how to retrieve discrete latent representations having as low entropy as possible.

In other words, the target problem of the former approaches may be regarded as how to include as much information as possible in a fixed number of representations, whereas the target problem of the latter approaches may be regarded as how to reduce the expected bit rate when a sufficient number of representations are given. Here, it may be assumed that low entropy corresponds to a low bit rate from entropy coding.

In order to solve the target problem of the latter approaches, the approaches may employ their own entropy models for approximating the actual distributions of discrete latent representations.

For example, some approaches may propose new frameworks that exploit entropy models, and may prove the performance of the entropy models by comparing the results generated by the entropy models with those of existing codecs, such as JPEG2000.

In these approaches, it may be assumed that each representation has a fixed distribution. In approaches, an input-adaptive entropy model for estimating the scale of the distribution of each representation may be used. Such an approach may be based on the characteristics of natural images indicating that the scales of representations are varying together within adjacent areas.

One of the principal elements in end-to-end optimized image compression may be a trainable entropy model used for latent representations.

Since the actual distributions of latent representations are not known, entropy models may calculate estimated bits for encoding latent representations by approximating the distributions of the latent representations.

In FIG. 1, x may denote an input image. x′ may denote an output image,

Q may denote quantization.

ŷ may denote quantized latent representations.

When the input image x is transformed into a latent representation y, and the latent representation y is uniformly quantized into a quantized latent representation ŷ by Q, a simple entropy model may be represented by p_{ŷ}(ŷ). The entropy model may be an approximation of actual entropy.

m(ŷ) may indicate the actual marginal distribution of ŷ. A rate estimation calculated through cross entropy that uses the entropy model p_{ŷ}(ŷ) may be represented by the following Equation 1.

R= [symbol] _{ŷ˜m}[−log₂p_{ŷ}(ŷ)]=H(m)+D_{KL}(m∥p_{ŷ}) [Equation 1]

The rate estimation may be decomposed into the actual entropy of ŷ and additional bits. In other words, the rate estimation may include the actual entropy of ŷ and the additional bits.

The additional bits may result from the mismatch between actual distributions and the estimations of the actual distributions.

Therefore, during a training process, decreasing a rate term R allows the entropy model p_{ŷ}(ŷ) to approximate the m(ŷ) as closely as possible, and other parameters may smoothly transform x into y so that the actual entropy of ŷ is reduced.

From the standpoint of Kullback-Leibler (KL)-divergence, R may be minimized when p_{ŷ}(ŷ) completely matches the actual distribution m(ŷ). This may mean that the compression performance of the above-described methods may essentially depend on the performance of the entropy models.

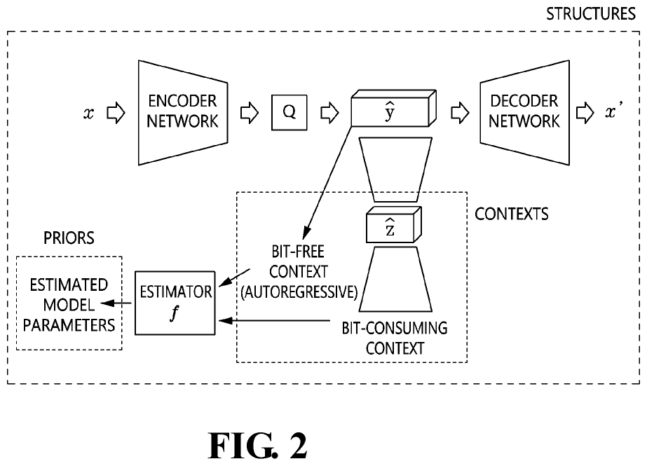

FIG. 2 illustrates extension to an autoregressive approach according to an example.

As three aspects of an autoregressive approach, there may be a structure, a context, and a prior.

“Structure” may mean how various building blocks are to be combined with each other. Various building blocks may include hyperparameters, skip connection, non-linearity, Generalized Divisive Normalization (GDN), attention layers, etc.

“Context” may be exploited for model estimation. The target of exploitation may include an adjacent known area, positional information, side information from z, etc.

“Prior” may mean distributions used to estimate the actual distribution of latent representations. For example, ‘prior’ may include a zero-mean Gaussian distribution, a Gaussian distribution, a Laplacian distribution, a Gaussian scale mixture distribution, a Gaussian mixture distribution, a non-parametric distribution, etc.

In an embodiment, in order to improve performance, a new entropy model that exploits two types of contexts may be proposed. The two types of contexts may be a bit-consuming context and a bit-free context. The bit-free context may be used for autoregressive approaches.

The bit-consuming context and the bit-free context may be classified depending on whether the corresponding context requires the allocation of additional bits for transmission.

By utilizing these types of contexts, the proposed entropy model may more accurately estimate the distribution of each latent representation using a more generalized form of entropy models. Also, the proposed entropy model may more efficiently reduce spatial dependencies between adjacent latent representations through such accurate estimation.

The following effects may be acquired through the embodiments to be described later.
A new context-adaptive entropy model framework for incorporating two different types of contexts may be provided.
The improvement directions of methods according to embodiments may be described in terms of the model capacity and the level of contexts.
In an ANN-based image compression domain, test results outperforming existing image codecs that are widely used in terms of a peak Signal-to-Noise Ratio (PSNR) may be provided.

Further, the following descriptions related to the embodiments will be made later.

1) Key approaches of end-to-end optimized image compression may be introduced, and a context-adaptive entropy model may be proposed.

2) The structures of encoder and decoder models may be described.

3) The setup and results of experiments may be provided.

4) The current states and improvement directions of embodiments may be described.

### Entropy Models of End-to-End Optimization Based on Context-Adaptive Entropy Models

The entropy models according to embodiments may approximate the distribution of discrete latent representations. By means of this approximation, the entropy models may improve image compression performance.

Some of the entropy models according to the embodiments may be assumed to be non-parametric models, and others may be Gaussian-scale mixture models, each composed of six-weighted zero-mean Gaussian models per representation.

Although it is assumed that the forms of entropy models are different from each other, the entropy models may have a common feature in that the entropy models concentrate on learning the distributions of representations without considering input adaptability. In other words, once entropy models are trained, the models trained for the representations may be fixed for any input during a test time.

In contrast, a specific entropy model may employ input-adaptive scale estimation for representations. The assumption that latent representation scales from natural images tend to move together within an adjacent area may be applied to such an entropy model.

In order to reduce such redundancy, the entropy models may use a small amount of side information. By means of the side information, proper scale parameters (e.g., standard deviations) of latent representations may be estimated.

In addition to scale estimation, when a prior probability density function (PDF) for each representation in a continuous domain is convolved with a standard uniform density function, the entropy models may much more closely approximate the prior probability mass function (PMF) of the discrete latent representation, which is uniformly quantized by rounding.

For training, uniform noise may be added to each latent representation. This addition may be intended to fit the distribution of noisy representations into the above-mentioned PMF-approximating functions.

By means of these approaches, the entropy models may achieve the newest (state-of-the-art) compression performance, close to that of Better Portable Graphics (BPG).

### Spatial Dependencies of Latent Variables

When latent representations are transformed over a convolutional neural network, the same convolution filters are shared across spatial regions, and natural images have various factors in common in adjacent regions, and thus the latent representations may essentially contain spatial dependencies.

In entropy models, these spatial dependencies may be successfully captured and compression performance may be improved by input-adaptively estimating standard deviations of the latent representations.

Moreover, in addition to standard deviations, the form of an estimated distribution may be generalized through the estimation of a mean that exploits contexts.

For example, assuming that certain representations tend to have similar values within spatially adjacent areas, when all neighboring representations have a value of 10, it may be intuitively predicted that the possibility that the current representation will have values equal to or similar to 10 is relatively strong. Therefore, this simple estimation may decrease entropy.

Similarly, the entropy model according to the method in the embodiment may use a given context so as to estimate the mean and the standard deviation of each latent representation.

Alternatively, the entropy model may perform context-adaptive entropy coding by estimating the probability of each binary representation.

However, such context-adaptive entropy coding may be regarded as separate components, rather than as one of end-to-end optimization components, because the probability estimation thereof does not directly contribute to the rate term of a Rate-Distortion (R-D) optimization framework.

The latent variables m(ŷ) of two different approaches and normalized versions of these latent variables may be exemplified. By means of the foregoing two types of contexts, one approach may estimate only standard deviation parameters, and the other may estimate the mean and the standard deviation parameters. Here, when the mean is estimated together with the given contexts, spatial dependency may be more efficiently removed.

### Context-Adaptive Entropy Model

In the optimization problem in the embodiment, an input image x may be transformed into a latent representation y having low entropy, and spatial dependencies of y may be captured into \hat{z}. Therefore, four fundamental parametric transform functions may be used. The four parametric transform function parameters of the entropy model may be given by 1) to 4).

1) Analysis transform hₐ(x:ϕ_{g}) for transforming x into a latent representation y

2) Synthesis transform gₛ(ŷ; θ_{g}) for generating a reconstructed image \hat{x}

3) Analysis transform hₐ(ŷ; ϕₕ) for capturing spatial redundancies of ŷ into a latent representation z

4) Synthesis transform hₛ(\hat{z}; θₕ) for generating contexts for model estimation.

In an embodiment, hₛ may not directly estimate standard deviations of representations. Instead, in an embodiment, hₛ may be used to generate a context c′, which is one of multiple types of contents, so as to estimate the distribution. The multiple types of contexts will be described later.

From the viewpoint of a variational autoencoder, the optimization problem may be analyzed, and the minimization of Kullback-Leibler Divergence (KL-divergence) may be regarded as the same problem as the R-D optimization of image compression. Basically, in an embodiment, the same concept may be employed. However, for training, in an embodiment, discrete representations on conditions, instead of noisy representations, may be used, and thus the noisy representations may be used only as the inputs of entropy models.

Experientially, the use of discrete representations on conditions may produce better results. These results may be due to the removal of mismatch between the conditions of a training time and a testing time and the increase of training capacity caused by the removal of the mismatch. The training capacity may be improved by restricting the effect of uniform noise only to help the approximation to probability mass functions.

In an embodiment, in order to handle discontinuities from uniform quantization, a gradient overriding method having an identity function may be used. The resulting objective functions used in the embodiment may be given by the following Equation 2.

[symbol]

=R+λD [Equation 2]

with R= [symbol] _{x˜p}_{ₓ} [symbol] _{\tilde{y},\tilde{x}˜q}[−log p_{\tilde{y}|\hat{z}}(\tilde{y}|\hat{z})−log p_{\tilde{z}}(\tilde{z})]

D= [symbol] _{x˜p}_{ₓ}[−log p_{x|ŷ}(x|ŷ)]

In Equation 2, total loss includes two terms. The two terms may indicate rates and distortions. In other words, the total loss may include a rate term R and a distortion term D

The coefficient λ may control the balance between the rates and the distortions during an R-D optimization process.

$$[ Equation 3 ]$$

$$q ( \tilde{y} , \tilde{z} \vert x , {ϕ}_{g} , {ϕ}_{h} ) = {\prod }_{i} 𝒰 ( {\tilde{y}}_{i} \vert {y}_{i} - \frac{1}{2} , {y}_{i} + \frac{1}{2} ) \cdot {\prod }_{j} 𝒰 ( {\tilde{z}}_{j} \vert {z}_{j} - \frac{1}{2} , {z}_{j} + \frac{1}{2} )$$

$$with y = {g}_{a} ( x ; {ϕ}_{g} ) , \hat{y} = Q ( y ) , z = {h}_{a} ( \hat{y} ; {ϕ}_{h} )$$

Here, when y is the result of a transform gₐ and z is the result of a transform hₐ, noisy representations of \tilde{y} and \tilde{z} may follow a standard uniform distribution. Here, the mean of \tilde{y} may be y, and the mean of \tilde{z} may be z. Also, input to hₐ may be ŷ other than the noisy representation \tilde{y}. ŷ may indicate uniformly quantized representations of y caused by a rounding function Q.

The rate term may indicate expected bits calculated with the entropy models of p_{\tilde{y}|\hat{z}} and p_{\tilde{z}}. p_{\tilde{y}|\hat{z}} may eventually be the approximation of p_{ŷ|\hat{z}} and p_{\tilde{z}} may eventually be the approximation of p_{\hat{z}}.

The following Equation 4 may indicate an entropy model for approximating the bits required for ŷ. In addition, Equation 4 may be a formal expression of the entropy model.

$$[ Equation 4 ]$$

$${p}_{\tilde{y} \vert \hat{z}} ( \tilde{y} \vert \hat{z} , {θ}_{h} , = {\prod }_{i} ( 𝒩 ( {μ}_{i} , {σ}_{i}^{2} ) * 𝒰 ( - \frac{1}{2} , \frac{1}{2} ) ) ( {\tilde{y}}_{i} )$$

$$with$$

$${μ}_{i} , {σ}_{i} = f ( {c}_{i}^{′} , {c}_{i}^{″} ) ,$$

$${c}_{i}^{′} = {E}^{′} ( {h}_{s} ( \hat{z} ; {θ}_{h} ) , i ) ,$$

$${c}_{i}^{″} = {E}^{″} ( 〈 y 〉 , i ) ,$$

$$\hat{z} = Q ( z )$$

The entropy model may be based on a Gaussian model having not only a standard deviation parameter σᵢ but also a mean parameter μᵢ.

The values of σᵢ and μᵢ may be estimated from the two types of given contexts based on a function f in a deterministic manner. The function f may be an estimator. In the description of the embodiments, the terms “estimator”, “distribution estimator”, “model estimator”, and “model parameter estimator” may have the same meaning, and may be used interchangeably with each other.

The two types of contexts may be a bit-consuming context and a bit-free context, respectively. Here, the two types of contexts for estimating the distribution of a certain representation may be indicated by c′ᵢ and c″ᵢ respectively.

An extractor E′ may extract c′ᵢ from c′. c′ may be the result of the transform hₛ.

In contrast to c′, the allocation of an additional bit may not be required for c″ᵢ. Instead, known (previously entropy-encoded or entropy-decoded) subsets of ŷ may be used. The known subsets of ŷ may be represented by [symbol] ŷ [symbol] .

An extractor E″ may extract c″ᵢ from [symbol] ŷ [symbol] .

An entropy encoder and an entropy decoder may sequentially process ŷᵢ in the same specific order, such as in raster scanning. Therefore, when the same ŷᵢ is processed, [symbol] ŷ [symbol] given to the entropy encoder and the entropy decoder may always be identical.

In the case of \hat{z}, a simple entropy model is used. Such a simple entropy model may be assumed to follow zero-mean Gaussian distributions having a trainable σ.

\hat{z} may be regarded as side information, and may make a very small contribution to the total bit rate. Therefore, in an embodiment, a simplified version of the entropy model, other than more complicated entropy models, may be used for end-to-end optimization in all parameters of the proposed method.

The following Equation 5 may indicate a simplified version of the entropy model.

$${p}_{\tilde{z}} ( \tilde{z} ) = {\prod }_{j} ( 𝒩 ( O , {σ}_{j}^{2} ) * 𝒰 ( - \frac{1}{2} , \frac{1}{2} ) ) ( {\tilde{z}}_{j} ) \qquad [ Equation 5 ]$$

A rate term may be an estimation calculated from entropy models, as described above, rather than the amount of real bits. Therefore, in training or encoding, actual entropy-encoding or entropy-decoding processes may not be essentially required.

In the case of a distortion term, it may be assumed that p_{x|ŷ} follows a Gaussian distribution, which is a widely used distortion metric. Under the assumption, the distortion term may be calculated using a Mean-Squared Error (MSE).

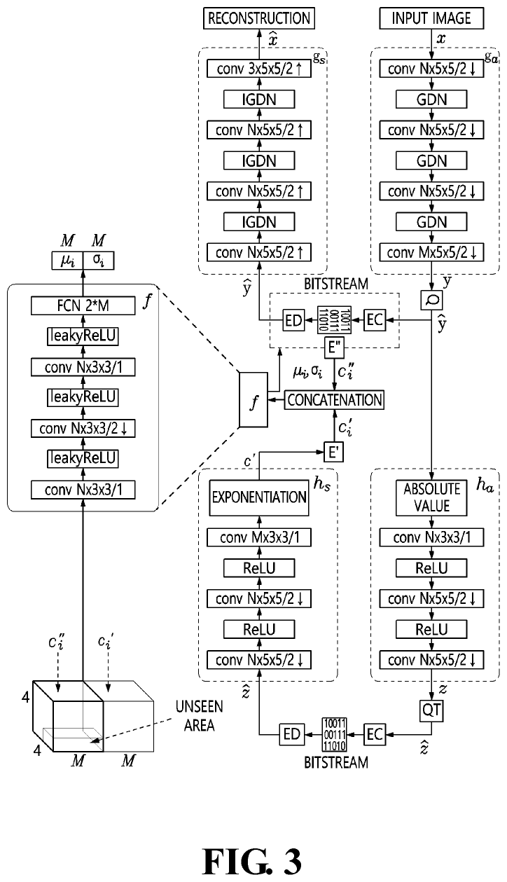

FIG. 3 illustrates the implementation of an autoencoder according to an embodiment.

In FIG. 3, convolution has been abbreviated as “conv”. “GDN” may indicate generalized divisive normalization. “IGDN” may indicate inverse generalized divisive normalization.

In FIG. 3, leakyReLU may be a function, which is a deformation of ReLU, and may also be a function by which the degree of leakage is specified. A first set value and a second set value may be established for the leakyReLU function. The leakyReLU function may output an input value and the second set value without outputting the first set value when the input value is less than or equal to the first set value.

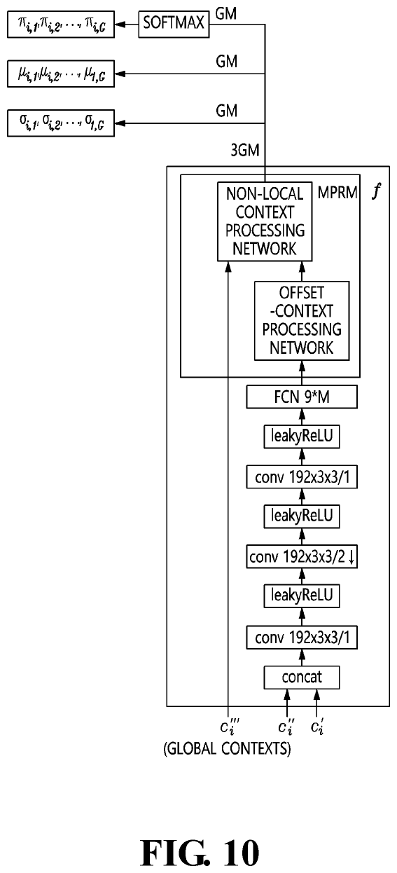

Also, the notations of convolutional layers used in FIG. 10 may be described as follows: the number of filters×filter height×filter width/(downscale or upscale factor).

Further, ↑ and ↓ may indicate up-scaling and down-scaling, respectively. For up-scaling and down-scaling, a transposed convolution may be used.

The convolutional neural networks may be used to implement transform and reconstruction functions.

Descriptions in the other embodiments described above may be applied to gₐ, gₛ, hₐ, and hₛ illustrated in FIG. 3. Also, at the end of hₛ, an exponentiation operator, rather than an absolute (value) operator, may be used.

Components for estimating the distribution of each ŷᵢ are added to the convolutional autoencoder.

In FIG. 3, “Q” may denote uniform quantization (i.e., rounding). “EC” may denote entropy encoding. “ED” may denote entropy decoding. “f” may denote a distribution estimator.

Also, the convolutional autoencoder may be implemented using the convolutional layers. Inputs to the convolutional layers may be channel-wisely concatenated c′ᵢ and c″ᵢ.The convolutional layers may output the estimated μᵢ and the estimated σᵢ as results.

Here, the same c′ᵢ and c″ᵢ may be shared by all ŷᵢ located at the same spatial position.

E′ may extract all spatially-adjacent elements from c′ across the channels so as to retrieve c′ᵢ. Similarly, E″ may extract all adjacent known elements from [symbol] ŷ [symbol] for c″ᵢ. The extractions by the E′ and E″ may have the effect of capturing the remaining correlations between different channels.

The distribution estimator f may extract, from the same spatial position, 1) all M, 2) the total number of channels of y, and 3) distributions of ŷᵢ, at one step, and by these extractions, the total number of estimations may be decreased.

Further, parameters of f may be shared for all spatial positions of ŷ. Thus, by means of this sharing, only one trained f per λ may be required in order to process any sized images.

However, in the case of training, in spite of the above-described simplifications, collecting the results from all spatial positions to calculate a rate term may be a great burden. In order to reduce such a burden, a specific number of random spatial points (e.g., 16) at every training step fir a context-adaptive entropy model may be designated as representatives. Such designation may facilitate the calculation of the rate term. Here, the random spatial points may be used only for the rate term. In contrast, the distortion term may still be calculated for all images.

Since y is a three-dimensional (3D) array, the index i of y may include three indices k, l, and m. Here, k may be a horizontal index, l may be a vertical index, and in may be a channel index.

When the current position is (k, l, m), E′ may extract c′_{[k-2 . . . k+1], [l-3 . . . l], [1 . . . M]} as c′ᵢ . Also, E″ may extract [symbol] ŷ [symbol] _{[k-2 . . . k+1], [l-3 . . . l], [1 . . . M]} as c″ᵢ. Here, [symbol] ŷ [symbol] may indicate the known area of ŷ.

The unknown area of [symbol] ŷ [symbol] may be padded with zeros (0). Because the unknown area of [symbol] ŷ [symbol] is padded with zeros, the dimension of [symbol] ŷ [symbol] may remain identical to that of ŷ. Therefore, c″_{i [3 . . . 4], 4 , [1 . . . M]} may always be padded with zeros.

In order to maintain the dimension of the estimated results at the input, marginal areas of c′ and [symbol] ŷ [symbol] may also be set to zeros.

When training or encoding is performed, c″ᵢ may be extracted using simple 4×4×M windows and binary masks. Such extraction may enable parallel processing. Meanwhile, in decoding, sequential reconstruction may be used.

As an additional implementation technique for reducing implementation costs, a hybrid approach may be used. The entropy model according to an embodiment may be combined with a lightweight entropy model. In the lightweight entropy model, representations may be assumed to follow a zero-mean Gaussian model having estimated standard deviations.

Such a hybrid approach may be utilized for the top-four cases in descending order of bit rate, among nine configurations. In the case of this utilization, it may be assumed that, for higher-quality compression, the number of sparse representations having a very low spatial dependency increases, and thus direct scale estimation provides sufficient performance for these added representations.

In implementation, the latent representation y may be split into two parts y₁ and y₂. Two different entropy models may be applied to y₁ and y₂, respectively. The parameters of gₐ, gₛ, hₐ and hₛ may be shared, and all parameters may still be trained together.

For example, for bottom-five configurations having lower bit rates, the number of parameters N may be set to 182. The number of parameters M may be set to 192. A slightly larger number of parameters may be used for higher configurations.

For actual entropy encoding, an arithmetic encoder may be used. The arithmetic encoder may perform the above-described bitstream generation and reconstruction using the estimated model parameters.

As described above, based on an ANN-based image compression approach that exploits entropy models, the entropy models according to the embodiment may be extended to exploit two different types of contexts.

These contexts allow the entropy models to more accurately estimate the distribution of representations with a generalized form having both mean parameters and standard deviation parameters.

The exploited contexts may be divided into two types. One of the two types may be a kind of free context, and may contain the part of latent variables known both to the encoder and to the decoder. The other of the two types may be contexts requiring the allocation of additional bits to be shared. The former may indicate contexts generally used by various codecs. The latter may indicate contexts verified to be helpful in compression. In an embodiment, the framework of entropy models exploiting these contexts has been provided.

In addition, various methods for improving performance according to embodiments may be taken into consideration.

One method for improving performance may be intended to generalize a distribution model that is the basis of entropy models. In an embodiment, performance may be improved by generalizing previous entropy models, and greatly acceptable results may be retrieved. However, Gaussian-based entropy models may apparently have limited expression power.

For example, when more elaborate models such as non-parametric models are combined with context-adaptivity in the embodiments, this combination may provide better results by reducing the mismatch between actual distributions and the estimated models.

An additional method for improving performance may be intended to improve the levels of contexts.

The present embodiment may use representations at lower levels within limited adjacent areas. When the sufficient capacity of networks and higher levels of contexts are given, more accurate estimation may be performed according to the embodiment.

For example, for the structures of human faces, when each entropy model understands that the structures generally have two eyes and symmetry is present between the two eyes, the entropy model may more accurately approximate distributions when encoding the remaining one eye by referencing the shape and position of one given eye.

For example, a generative entropy model may learn the distribution p(x) of images in a specific domain, such as human faces and bedrooms. Also, in-painting methods may learn a conditional distribution p(x|context) when viewed areas are given as context. Such high-level understanding may be combined with the embodiment.

Moreover, contexts provided through side information may be extended to high-level information, such as segmentation maps and additional information helping compression. For example, the segmentation maps may help the entropy models estimate the distribution of a representation discriminatively according to the segment class to which the representation belongs.

### End-to-End Joint Learning Scheme of Image Compression and Quality Enhancement With Improved Entropy Minimization

In relation to the end-to-end joint learning scheme in an embodiment, the following technology may be used.

1) Approaches based on an entropy model: end-to-end optimized image compression may be used, and lossy image compression using a compressive autoencoder may be used.

2) Scale parameters for estimating hierarchical priors of latent representations: variational image compression having a scale hyperprior may be used.

3) Utilization of latent representations jointly adjacent to a context from a hyperprior as additional contexts: a joint autoregressive and hierarchical prior may be used for learned image compression, and a context-adaptive entropy model may be used for end-to-end optimized image compression.

In an embodiment, for contexts, the following features can be taken into consideration.

1) Spatial correlation: in autoregressive methods, existing approaches may exploit only adjacent regions. However, many representations may be repeated within a real-world image real-image). The remaining non-local correlations need to be removed.

2) Inter-channel correlation: correlations between different channels in latent representations may be efficiently removed. Also, inter-channel correlations may be utilized.

Therefore, in embodiments, for contexts, spatial correlations with newly defined non-local contexts may be removed.

In embodiments, for structures, the following features may be taken into consideration. Methods for quality enhancement may be jointly optimized in image compression.

In embodiments, for priors, the following problems and features may be taken into consideration: approaches using Gaussian priors can be limited with regard to expression power, and can have constraints on fitting to actual distributions. As the prior is further generalized, higher compression performance may be obtained through more precise approximation to actual distributions.

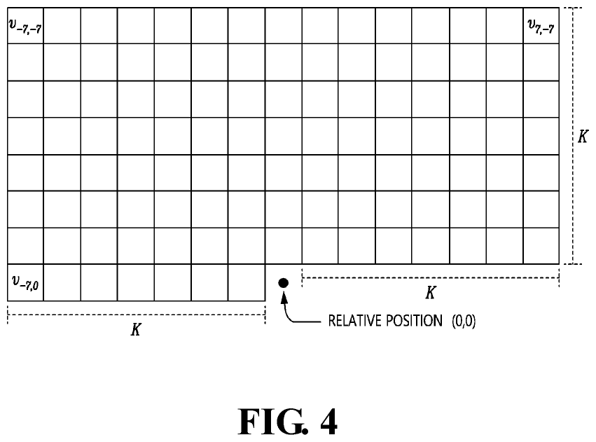

FIG. 4 illustrates trainable variables for an image according to an example.

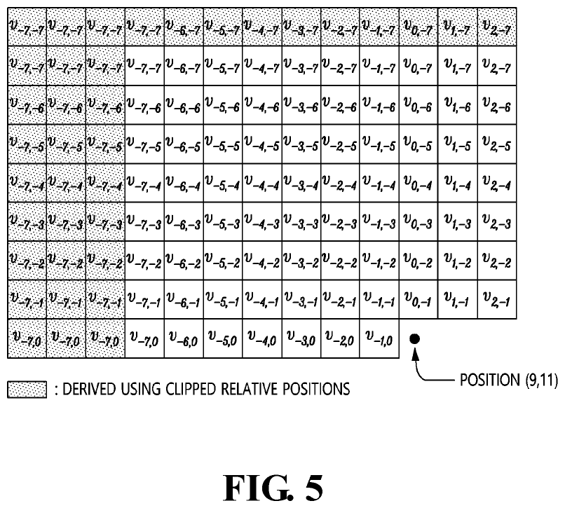

FIG. 5 illustrates derivation using clipped relative locations.

The following elements may be used for contexts for removing non-local correlations:
Weighted sample average and variance of known latent representations for each channel
Fixed weights for variable-size regions

The term “non-local context” may mean a context for removing non-local correlations.

A non-local context cₗ^{n.l.} may be defined by the following Equation 6.

$$[ Equation 6 ]$$

$${c}_{i}^{n . l .} = \{ {μ}_{0}^{*} … , {μ}_{j}^{*} , {σ}_{0}^{*} , … , {σ}_{J}^{*}$$

$$with$$

$$\begin{matrix}{σ}_{j}^{*} = \sqrt{\frac{{\sum }_{k , l ∈ S} {{w}_{j , k , l} ( {h}_{j , k , l} - {μ}_{j}^{*} )}^{2}}{1 - {\sum }_{k , l ∈ S} {w}_{j , k , l}^{2}}} , \\ {μ}_{j}^{*} = {\sum }_{k , l ∈ S} {w}_{j , k , l} {h}_{j , k , l} ,\end{matrix}$$

With regard to Equation 6, Equations 7 and 8 may be used.

h=H( [symbol] ŷ [symbol] ), [Equation 7]

with [symbol] ŷ [symbol] ={y_{j, k, l}|k, l ∈S}

w={w₀, . . . , w_{J}} [Equation 8]

with wⱼ=softmax(aₗ),

aⱼ={a_{j, k, l}|k, l ∈S},

a_{j, k, l}=v_{j,clip(k-k}_{_{cur}}_{,K),clip(l-l}_{_{cur}}_{,K)},

clip(x, K)=max(−K, min(K, x))

H may denote a linear function.

j may denote an index for a channel, k may denote an index for a vertical axis. l may denote an index for a horizontal axis.

k may be a constant for determining the number of trainable variables in vⱼ.

In FIG. 4, trainable variables vⱼ for a current position are illustrated.

The current position may be the position of the target of encoding and/or decoding.

The trainable variables may be variables having a distance of k or less from the current position. The distance from the current position may be one having the greater difference of 1) the difference between the current x coordinate and the x coordinate of the corresponding variable and 2) the difference between the current y coordinate and the y coordinate of the corresponding variable.

In FIG. 5, variables derived using clipped relative positions are depicted.

In FIG, 5, the case where the current position is (9, 11) and the width is 13 is shown by way of example.

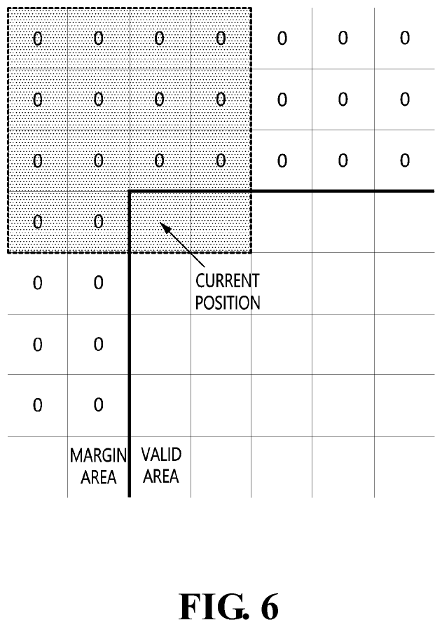

FIG. 6 illustrates offsets for the current position (0, 0) according to an example.

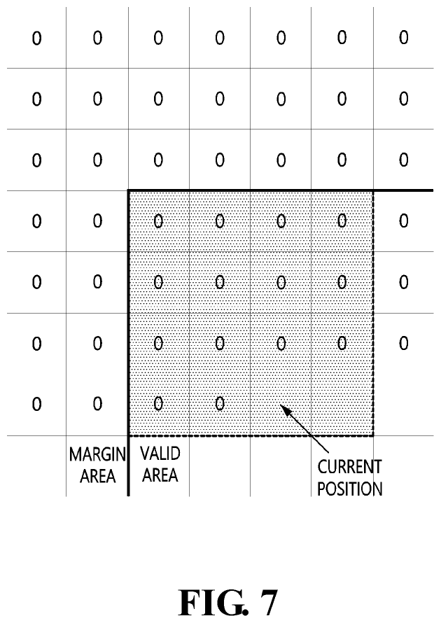

FIG. 7 illustrates offsets for the current position (2, 3) according to an example.

In an embodiment, contexts indicating offsets from borders may be used.

Due to the ambiguity of zero values in margin areas, conditional distributions of latent representations may differ depending on spatial positions. In consideration of these features, offsets may be utilized as contexts.

The offsets may be contexts indicating offsets from borders.

In FIGS. 6 and 7, the current position, an effective area, and a margin area are illustrated.

In FIG. 6, offsets (L, R, T, B) may be (0, w-1, 0, h-1) and in FIG. 7, offsets (L, R, T, B) may be (2, w-3, 3, h-4).

R, T and B may mean left, right, top, and bottom positions. w may be the width of an input image. h may be the height of the input image.

### Network Architecture

### Joint Learning Scheme of Image Compression and Quality Enhancement

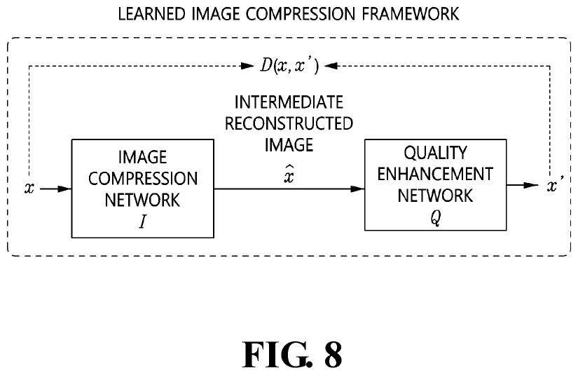

FIG. 8 illustrates an end-to-end joint learning scheme for image compression and quality enhancement combined in a cascading manner according to an embodiment.

In FIG. 8, structures for embracing quality enhancement networks are illustrated.

In an embodiment, the disclosed image compression network may employ an existing image quality enhancement network for the end-to-end joint learning scheme. The image compression network may jointly optimize image compression and quality enhancement.

Therefore, the architecture in the embodiment may provide high flexibility and high extensibility. In particular, the method in the embodiment may easily accommodate future advanced image quality enhancement networks, and may allow various combinations of image compression methods and quality enhancement methods. That is, individually developed image compression networks and image (quality) enhancement networks may be easily combined with each other within a unified architecture that minimizes total loss, as represented by the following Equation 9, and may be easily jointed and optimized.

[symbol]

=R+λD(x, Q(I(x))) [Equation 9]

[symbol] may denote the total loss.

I may denote image compression which uses an input image x as input. In other words, I may be an image compression sub-network.

Q may be a quality enhancement function which uses a reconstructed image \hat{x} is as an input. In other words, Q may be a quality enhancement sub-network.

Here, \hat{x} may be I(x). Also, \hat{x} may be an intermediate reconstruction output of I, R, D, and λ.

R may denote a rate.

D may denote distortion. D(x,Q(I(x))) may denote distortion between x and Q(I(x)).

λ may denote a balancing parameter.

In conventional methods, the image compression sub-network I may be trained such that output images are reconstructed to have as little distortion as possible. In contrast with these conventional methods, the outputs of I in the embodiment may be regarded as intermediate latent representations \hat{x}. \hat{x} may be input to the quality enhancement sub-network Q.

Therefore, distortion D may be measured between 1) the input image x and 2) a final output image x′, which is reconstructed by Q.

Here, x′ may be Q(\hat{x}).

Therefore, the architecture in the embodiment may jointly optimize the two sub-networks I and Q so that the total loss [symbol] in Equation 9 is minimized. Here, \hat{x} may be optimally represented in the sense that Q outputs the final reconstruction with high fidelity.

An embodiment may present a joint end-to-end learning scheme for both image compression and quality enhancement rather than a customized quality enhancement network. Therefore, in order to select a suitable quality enhancement network, reference image compression methods may be combined with various quality enhancement methods in cascading connections.

In an embodiment, the image compression network may utilize verified wisdom of quality enhancement networks. The verified wisdom of the quality enhancement network may include super-resolution and artifact reduction. For example, the quality enhancement network may include a very deep super resolution network (VDSR), a residual dense network (RDN), and a grouped residual dense network (GRDN).

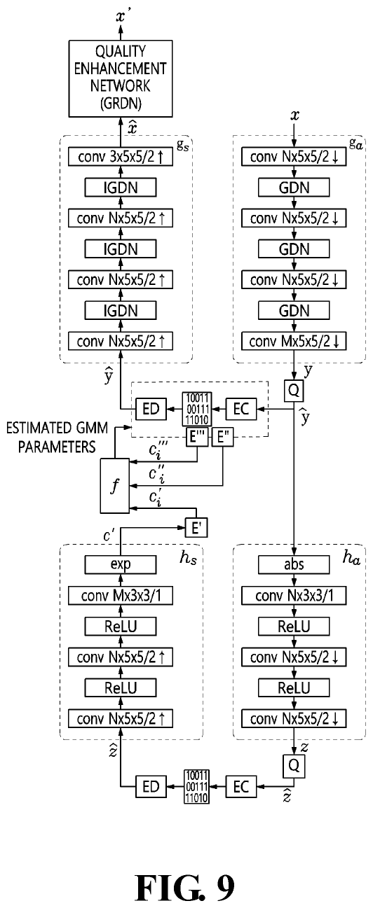

FIG. 9 illustrates the overall network architecture of an image compression network according to an embodiment.

FIG. 9 may show the architecture of an image compression network, which is an autoencoder. The architecture of the autoencoder may correspond to an encoder and a decoder.

In other words, for the encoder and the decoder, a convolutional autoencoder structure may be used, and a distribution estimator f may also be implemented together with convolutional neural networks.

In FIG. 9 and subsequent drawings, for the architecture of the image compression network, the following abbreviations and notations may be used.
gₐ may denote an analysis transform for transforming x into a latent representation y.
gₛ may denote a synthesis transform for generating a reconstructed image \hat{x}.
hₐ may denote an analysis transform for capturing spatial redundancies of ŷ into a latent representation z.
hₛ may denote a synthesis transform for generating contexts related to model estimation.
Rectangles marked with “conv” may denote convolutional layers.
A convolutional layer may be represented by “the number of filters”×“filter height”×“filter width”/“down-scaling or up-scaling factor”.
“↑” and “↓” respectively denote up-scaling and down-scaling through transposed convolutions.
An input image input may be normalized to fit a scale between −1 and 1.
In a convolutional layer, “N” and “M” may each indicate the number of feature map channels. Meanwhile, “M” in each fully-connected layer may be the number of nodes multiplied by its accompanying integer.
“GDN” may denote Generalized Divisive Normalization (GDN). “IGDN” may denote Inverse Generalized Divisive Normalization (IGDN).
“ReLU” may denote a Rectified Linear Unit (ReLU) layer.
“Q” may denote uniform quantization (rounding-off).
“EC” may denote an entropy-encoding process, “ED” may denote an entropy-decoding process.
“normalization” may denote normalization.
“denormalization” may denote denormalization.
“abs” may denote an absolute operator.
“exp” may denote an exponentiation operator.
“f” may denote a model parameter estimator.
E′, E″, and E′″ may denote respective functions for extracting three types of contexts.

In the image compression network, convolutional neural networks may be used to implement transform and reconstruction functions.

As described above with reference to FIG. 9, the image compression network and the quality enhancement network may be connected in a cascading manner. For example, the quality enhancement network may be a GRDN.

The above descriptions made in relation to rate-distortion optimization and transform functions may be applied to embodiments.

The image compression network may transform the input image x into latent representations y. Next, y may be quantized into ŷ.

The image compression network may use a hyperprior \hat{z}. \hat{z} may capture spatial correlations of ŷ.

The image compression network may use four basic transform functions. The transform functions may be the above-described analysis transform gₐ(x;ϕ_{g}), synthesis transform gₛ(ŷ; θ_{g}), analysis transform hₐ(ŷ; ϕₕ), and synthesis transform hₛ(\hat{z}; θₕ).

Descriptions of foregoing embodiments may be applied to gₐ, gₛ, hₐ, and hₛ illustrated in FIG. 9. Further, an exponentiation operator, rather than an absolute operator, may be used at the end of hₐ.

A rate-distortion optimization process according to the embodiment may ensure the image compression network to yield as low the entropy of ŷ and \hat{z} as possible. Further, the optimization process may ensure the image compression network to yield an output image x′ reconstructed from ŷ as close to the original visual quality as possible.

For this rate-distortion optimization, distortion between the input image x and the output image x′ may be calculated. The rate may be calculated based on prior probability models of ŷ and \hat{z}.

For \hat{z}, a simple zero-mean Gaussian model convolved with u(−½, ½) may be used. Standard deviations of the simple zero-mean Gaussian model may be provided through training. In contrast, as described above in connection with the foregoing embodiments, the prior probability model for ŷ may be estimated in an autoregressive manner by the model parameter estimator f.

As described above in connection with the foregoing embodiments, the model parameter estimator f may utilize two types of contexts.

The two types of contexts may be a bit-consuming context c′ᵢ and a bit-free context c″ᵢ.c′ᵢ may be reconstructed from the hyperprior \hat{z}. c″ᵢ may be extracted from adjacent known representations of ŷ.

In addition, in an embodiment, the model parameter estimator f may exploit a global context c″ᵢ so as to more precisely estimate the model parameters.

Through the use of three given contexts, f may estimate the parameters of a Gaussian Mixture Model (GMM) (convolved with u(−½, ½). In an embodiment, GMM may be employed as a prior probability model for ŷ. Such parameter estimation may be used for an entropy-encoding process and an entropy-decoding process, represented by “EC” and “ED”, respectively. Also, parameter estimation may also be used in the calculation of a rate term for training.

FIG. 10 illustrates the structure of a model parameter estimator according to an example.

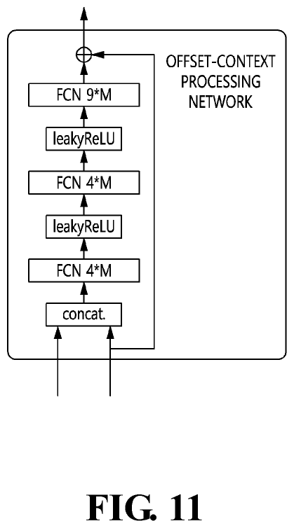

FIG. 11 illustrates a non-local processing network according to an example.

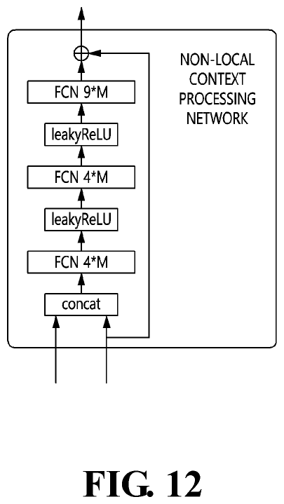

FIG. 12 illustrates an offset-context processing network according to an example.

In FIGS. 10, 11, and 12, for the architecture of the image compression network, the following abbreviations and notations may be used.
“FCN” may denote a fully-connected network.
“concat” may denote a concatenation operator.
“leakyReLU” may denote a leaky ReLU. The leaky ReLU may be a function which is a modification of a ReLU and which specifies a degree of leakiness. For example, a first set value and a second set value may be established for the leakyReLU function. The leakyReLU function may output an input value and the second set value without outputting the first set value when the input value is less than or equal to the first set value.

The structure of the model parameter estimator f may be improved by extending f to a new model estimator. The new model estimator may incorporate a model parameter refinement module (MPRM) to improve the capability of model parameter estimation.

The MPRM may have two residual blocks. The two residual blocks may be an offset-context processing network and a non-local context processing network.

Each of the two residual blocks may include fully-connected layers and the corresponding non-linear activation layers.

### Improved Entropy Models and Parameter Estimation for Entropy Minimization

The entropy-minimization method in the foregoing embodiment may exploit local contexts so as to estimate prior model parameters for each ŷᵢ. The entropy-minimization method may exploit neighbor latent representations of a current latent representation ŷᵢ so as to estimate a standard deviation parameter σᵢ and a mean parameter μᵢ of a single Gaussian prior model (convolved with a uniform function) for the current latent representation ŷᵢ.

These approaches may have the following two limitations.

(i) A single Gaussian model has a limited capability to model various distributions of latent representations. In an embodiment, a Gaussian mixture model (GMM) may be used.

(ii) Extracting context information from neighbor latent representations may be limited when correlations between the neighbor latent representations are spread over the entire spatial domain.

### Gaussian Mixture Model for Prior Distributions

The autoregressive approaches in the foregoing embodiment may use a single Gaussian distribution (or a Gaussian prior model) to model the distribution of each ŷᵢ. The transform networks of the autoregressive approaches may generate latent representations following single Gaussian distributions, but such single Gaussian modeling may be limitedly able to predict actual distributions of latent representations, thus leading to sub-optimal performance. Instead, in an embodiment, a more generalized form of the prior probability model, GMM, may be used. The GMM may more precisely approximate the actual distributions.

The following Equation 10 may indicate an entropy model using the GMM.

$$[ Equation 10 ]$$

$${p}_{\tilde{y} \vert \hat{z}} ( \tilde{y} \vert \hat{z} , {θ}_{h} ) = {\prod }_{i} ( {\sum }_{g = 1}^{G} {ϕ}_{gi} 𝒩 ( {μ}_{gi} , {σ}_{gi}^{2} ) * 𝒰 ( - \frac{1}{2} \cdot \frac{1}{2} ) ) ( {\tilde{y}}_{i} )$$

$$with$$

$$\{ {μ}_{gi} , {σ}_{gi} \vert 1 \leq g \leq G \} = f ( {c}_{i}^{′} , {c}_{i}^{″} ) ,$$

$${c}_{i}^{′} = {E}^{′} ( {h}_{s} ( \hat{z} ; {θ}_{h} ) , i ) ,$$

$${c}_{i}^{″} = {E}^{″} ( 〈 \hat{y} 〉 , i ) ,$$

$$\hat{z} = Q ( z )$$

### Formulation of Entropy Models

Basically, an R-D optimization framework described above with reference to Equation 9 in the foregoing embodiment may be used for an entropy model according to an embodiment.

A rate term may be composed of the cross-entropy for \tilde{z} and \tilde{y}|\hat{z}.

In order to deal with discontinuity due to quantization, a density function convolved with a uniform function u(−½,½) may be used to approximate the probability mass function (PMF) of ŷ. Therefore, in training, noisy representations \tilde{y} and \tilde{z} may be used to fit the actual sample distributions to probability mass function (PMF)-approximating functions. Here, \tilde{y} and \tilde{z} may follow uniform distribution, wherein the mean value of \tilde{y} may be y, and the mean value of \tilde{z} may be z.

In order to model the distribution of \tilde{z}, as described above in connection with the foregoing embodiment, zero-mean Gaussian density functions (convolved with a uniform density function) may be used. The standard deviations of the zero-mean Gaussian density functions may be optimized through training.

An entropy model for \tilde{y}|\hat{z} may be extended based on a GMM, as represented by the following Equations 11 and 13.

$$[ Equation 11 ]$$

$${p}_{\tilde{y} \vert \hat{z}} ( \tilde{y} \vert \hat{z} , {θ}_{h} ) = {\prod }_{i} ( {\sum }_{g = 1}^{G} {ϕ}_{i , g} 𝒩 ( {μ}_{i , g} , {σ}_{i , g}^{2} ) * 𝒰 ( - \frac{1}{2} \cdot \frac{1}{2} ) ) ( {\tilde{y}}_{i} )$$

$$with$$

$$\{ {μ}_{i , g} , {σ}_{i , g} \vert 1 \leq g \leq G \} = f ( {c}_{i}^{′} , {c}_{i}^{″} ) ,$$

$${c}_{i}^{′} = {E}^{′} ( {h}_{s} ( \hat{z} ; {θ}_{h} ) , i ) ,$$

$${c}_{i}^{″} = \{ {E}^{″} ( 〈 \hat{y} 〉 , i ) , {E}^{′′′} ( 〈 \hat{y} 〉 , i ) , {o}_{i} \} ,$$

$$\hat{z} = Q ( z )$$

In Equation 11, the following Equation 12 may indicate a Gaussian mixture.

$${\sum }_{g = 1}^{G} {ϕ}_{i , g} 𝒩 ( {μ}_{i , g} , {σ}_{i , g}^{2} ) \qquad [ Equation 12 ]$$

In Equation 11, E′″ ( [symbol] ŷ [symbol] ,i) may indicate non-local contexts.

Equation 11, Oi may indicate offsets. The offsets may be one-hot coded.

Equation 11 may denote the formulation of a combined model. Structural changes may be irrelevant to the model formulation of Equation 11.

$$[ Equation 13 ]$$

$${p}_{\tilde{y} \vert \hat{z}} ( \tilde{y} \vert \hat{z} , {θ}_{h} ) = {\prod }_{i} ( {\sum }_{g = 1}^{G} {π}_{i , g} 𝒩 ( {μ}_{i , g} , {σ}_{i , g}^{2} ) * 𝒰 ( - \frac{1}{2} , \frac{1}{2} ) ) ( {\tilde{y}}_{i} )$$

$$with \{ {π}_{i , g} , {μ}_{i , g} , {σ}_{i , g} \vert 1 \leq g \leq G \} = f ( {c}_{i}^{′} , {c}_{i}^{″} , {c}_{i}^{′′′} )$$

G may be the number of Gaussian distribution functions.

The model parameter estimator f may predict G parameters, and each of the G Gaussian distributions may have its own weight parameter π_{i,g}, mean parameter μ_{i,g}, and standard deviation parameter σ_{i,g} through prediction.

A mean-squared error (MSE) may be basically used, as a distortion term, for optimization of the above-described Equation 9. Further, as the distortion term, a multiscale-structural similarity (MS-SSIM) optimized model may be used.

### Global Context for Model Parameter Estimation

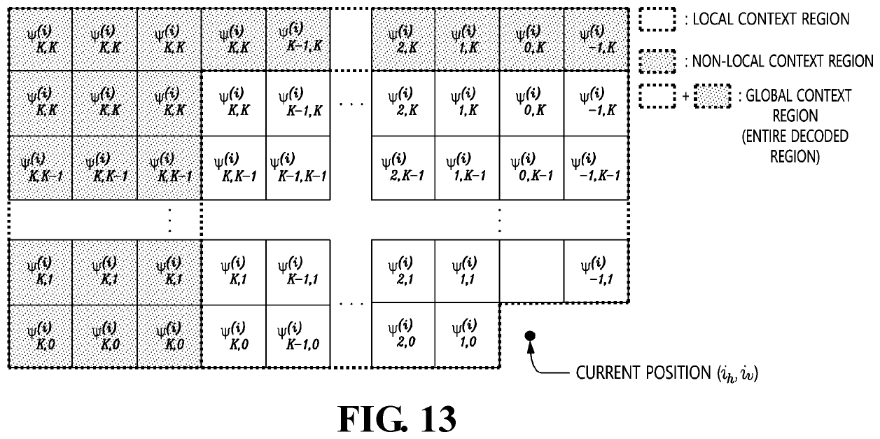

FIG. 13 illustrates variables mapped to a global context region according to an example.

In order to extract more desirable context information for a current latent representation, a global context may be used by aggregating all possible contexts from the entire area of known representations for estimating prior model parameters.

In order to use the global context, the global context may be defined as information aggregated from a local context region and a non-local context region.

Hereinafter, the terms “area” and “region” may be used as the same meaning, and may be used interchangeably with each other.

Here, the local context region may be a region within a fixed distance from the current latent representation yᵢ. K may denote a fixed distance. The non-local context region may be the entire causal area outside the local context region.

As the global context c′″ᵢ, a weighted mean value and a weighted standard deviation value aggregated from the global context region may be used.

The global context region may be the entire known spatial area in the channel of \dot{y}. \dot{y} may be a linearly transformed version of ŷ through a 1×1 convolutional layer.

The global context c′″ᵢ may be acquired from \dot{y} so as to capture correlations ŷ across the different channels of ŷ rather than from ŷ.

The global context c′″ᵢ may be represented by the following Equation 14.

c′″ᵢ={μ*ᵢ, σ*ᵢ} [Equation 14]

The global context c′″ᵢ may include a weighted mean μ*ᵢ and a weighted standard deviation σ*ᵢ.

μ*ᵢ may be defined by the following Equation 15:

$${μ}_{i}^{*} = {\sum }_{k , l ∈ S} {w}_{k , l}^{( i )} {\dot{y}}_{{i}_{h} - k , {i}_{v} - l}^{( i )} \qquad [ Equation 15 ]$$

σ*ᵢ may be defined by the following Equation 16.

$${σ}_{i}^{*} = \sqrt{\frac{{\sum }_{k , l ∈ S} {{w}_{k , l}^{( i )} ( {\dot{y}}_{{i}_{h} - k , {i}_{v} - l}^{( i )} - {μ}_{i}^{*} )}^{2}}{1 - {\sum }_{k , l ∈ S} {w}_{k , l}^{{( i )}^{2}}}} \qquad [ Equation 16 ]$$

i may be defined by the following Equation 17.

i=[i_{c}, iₕ, iᵥ] [Equation 17]

i may be a three-dimensional (3D) spatio-channel-wise position index indicating a current position (iₕ, iᵥ) in an i_{c}-th channel.

w_{k,l}⁽ⁱ⁾ may be a weight variable for relative coordinates (k, l) based on the current position (iₕ, iᵥ).

\dot{y}ᵢ_{ₕ}_{-k,i}_{ᵥ}₋ₗ⁽ⁱ⁾ may be a representation of \dot{y}⁽ⁱ⁾ at location (iₕ-k, iᵥ-l), within the global context region S.

\dot{y}⁽ⁱ⁾ may be the two-dimensional (2D) representations within the i_{c}-th channel of \dot{y}.

The weight variables in w⁽ⁱ⁾ may be the normalized weights. The normalized weights may be element-wise multiplied by \dot{y}⁽ⁱ⁾. In Equation 15, the weight variables may be element-wise multiplied by \dot{y}⁽ⁱ⁾ so as to calculate the weighted mean. In Equation 16, the weight variables may be multiplied by the difference squares of (\dot{y}ᵢ_{ₕ}_{-k,i}_{ᵥ}₋ₗ⁽ⁱ⁾−μ*ᵢ).

In an embodiment, the key issue is to find an optimal set of weight variables w⁽ⁱ⁾ from all locations i. In order to acquire w⁽ⁱ⁾ from a fixed number of trainable variables ψ⁽ⁱ⁾, w⁽ⁱ⁾ may be estimated based on a scheme for extracting a 1-dimensional (1D) global context region from a 2D extension.

In FIG. 13, a global context region including 1) a local context region within a fixed distance K and 2) a non-local context region having a variable size is illustrated.

The local context region may be covered by trainable variables ψ⁽ⁱ⁾. The non-local context region may be present outside the local context region.

In global context extraction, the non-local context region may be enlarged as a local context window, which defines the local context area, slides over a feature map. With the enlargement of the non-local context region, the number of weight variables w⁽ⁱ⁾ may be increased.

To handle the non-local context region which cannot be covered by a fixed size of trainable variables ψ⁽ⁱ⁾, a variable of ψ⁽ⁱ⁾ allocated to the nearest local context region is used for each spatial position within the non-local context region, as illustrated in FIG. 13.

As a result, a set of trainable variables ψ⁽ⁱ⁾, that is, a⁽ⁱ⁾, may be acquired. a⁽ⁱ⁾ may correspond to the global context region.

Next, w⁽ⁱ⁾ may be calculated by normalizing a⁽ⁱ⁾ using a softmax function, as shown in the following Equation 18.

w⁽ⁱ⁾=softmax(a⁽ⁱ⁾) [Equation 18]

a⁽ⁱ⁾ may be defined by the following Equation 19.

a⁽ⁱ⁾={ψ_{clip(k,K),clip(l,K)}⁽ⁱ⁾|k, l∈S} [Equation 19]

clip(x, K) may be defined by the following Equation 20.

clip(x, K)=max(−k, min(K, x) [Equation 20]

In the same channel (i.e., over the same spatial feature space), the following Equation 21 may be satisfied.

ψ_{k,l}⁽ⁱ⁾=ψ_{k,l}^{(i+c)} [Equation 21]

For some channels of \dot{y}, examples of the trained ψ⁽ⁱ⁾ may be visualized. For example, the context of channels may be dependent on neighbor representations immediately adjacent to the current latent representation. Alternatively, the context of the channel may be dependent on widely spread neighbor representations.

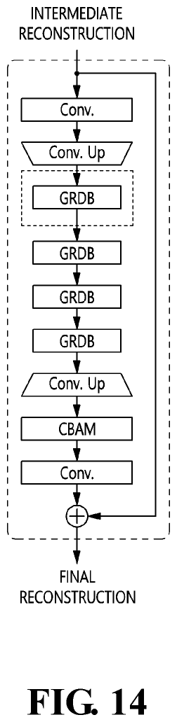

FIG. 14 illustrates the architecture of a GRDN according to an embodiment.

In an embodiment, intermediate reconstruction may be input to the GRDN, and the final reconstruction may be output from the GRDN.

In FIG. 14, for the architecture of the GRDN, the following abbreviations and notations may be used.
“GRDB” may denote a grouped residual dense block (GRDB).
“CBAM” may denote a convolutional block attention module (CBAM).
“Conv. Up” may denote convolution up-sampling.
“+” may denote an addition operation.

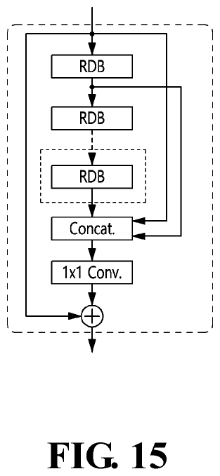

FIG. 15 illustrates the architecture of the GRDB of the GRDN according to an embodiment.

In FIG. 15, for the architecture of the GRDB, the following abbreviations and notations may be used:
“RDB” may denote a residual dense block (RDB).

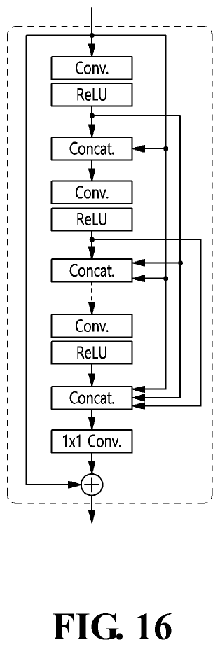

FIG. 16 illustrates the architecture of the RDB of the GRDB according to an embodiment.

As exemplified with reference to FIGS. 14, 15 and 16, four GRDBs may be used to implement a GRDN. Further, for each GRDB, three RDBs may be used. For each RDB, three convolutional layers may be used.

### Encoder-Decoder Model

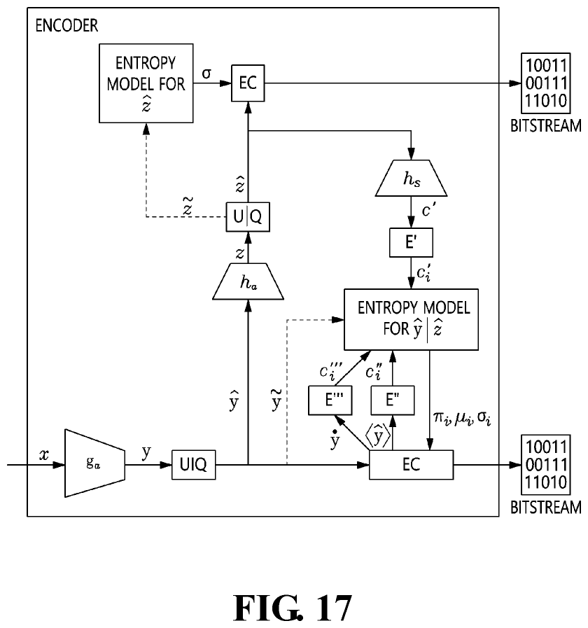

FIG. 17 illustrates an encoder according to an embodiment.

In FIG. 17, the small icons on the right may indicate entropy-encoded bitstreams.

In FIG. 17, EC may stand for entropy coding (i.e., entropy encoding). U|Q may denote uniform noise addition or uniform quantization.

In FIG. 17, noisy representations are indicated by dotted lines. In an embodiment, noisy representations may be used, as the input to entropy models, only for training.

As illustrated in FIG. 17, the encoder may include elements for an encoding process in the autoencoder, described above with reference to FIG. 9, and may perform encoding that is performed by the autoencoder. In other words, the encoder in the embodiment may be viewed from the aspect in which the autoencoder, described above with reference to FIG. 9, performs encoding on the input image.

Therefore, the description of the autoencoder, made above with reference to FIG. 9, may also be applied to the encoder according to the present embodiment.

The operations of the encoder and the decoder and the interaction therebetween will be described in detail below.

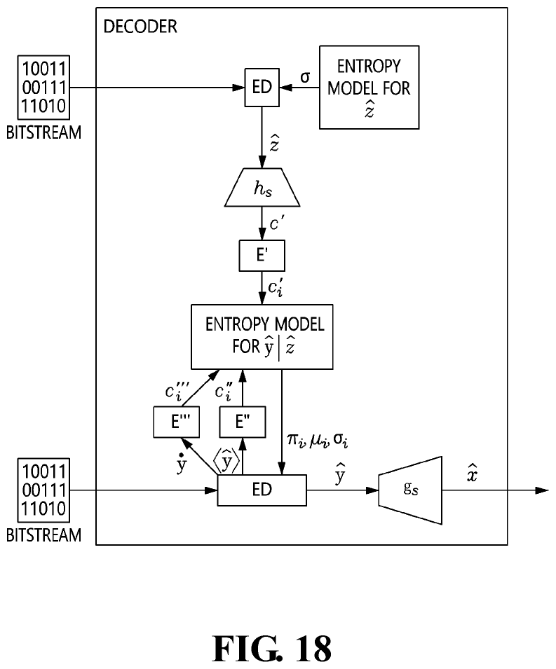

FIG. 18 illustrates a decoder according to an embodiment.

In FIG. 18, the small icons on the left indicate entropy-encoded bitstreams.

ED denotes entropy decoding.

As illustrated in FIG. 18, the decoder may include elements for a decoding process in the autoencoder, described above with reference to FIG. 9, and may perform decoding that is performed by the autoencoder. In other words, it can be seen that the decoder according to the embodiment is viewed from the aspect in which the autodecoder, described above with reference to FIG. 9, performs decoding on an input image.

Therefore, the description of the autoencoder, made above with reference to FIG. 9, may also be applied to the decoder according to the present embodiment.

The operations of the encoder and the decoder and the interaction therebetween will be described in detail below.

The encoder may transform an input image into latent representations.

The encoder may generate quantized latent representations by quantizing the latent representations. Also, the encoder may generate entropy-encoded latent representations by performing entropy encoding, which uses trained entropy models, on the quantized latent representations, and may output the entropy-encoded latent representations as bitstreams.

The trained entropy models may be shared between the encoder and the decoder. In other words, the trained entropy models may also be referred to as shared entropy models.

In contrast, the decoder may receive entropy-encoded latent representations through bitstreams. The decoder may generate latent representations by performing entropy decoding, which uses the shared entropy models, on the entropy-encoded latent representations. The decoder may generate a reconstructed image using the latent representations.

In the encoder and decoder, all parameters may be assumed to already be trained.

The structure of the encoder-decoder model may basically include gₐ and gₛ. gₐ may be in charge of transforming x into y, and gₛ may be in charge of performing an inverse transform corresponding to the transform of gₐ.

The transformed y may be uniformly quantized into ŷ through rounding.

Here, unlike in conventional codecs, in approaches based on entropy models, tuning of quantization steps is usually unnecessary because the scales of representations are optimized together via training.

Other components between gₐ and gₛ may function to perform entropy encoding (or entropy decoding) using 1) shared entropy models and 2) underlying context preparation processes.

More specifically, each entropy model may individually estimate the distribution of each ŷᵢ. In the estimation of the distribution of ŷᵢ, πᵢ, μᵢ, and σᵢ may be estimated with three types of given contexts, that is, c′ᵢ, c″ᵢ, and c′″ᵢ.

Of these contexts, c′ may be side information requiring the allocation of additional bits. In order to reduce the bit rate needed to carry c′, a latent representation z transformed from ŷ may be quantized and entropy-encoded by its own entropy model.

In contrast, c″ᵢ may be extracted from [symbol] ŷ [symbol] without allocating any additional bits. Here, [symbol] ŷ [symbol] may change as entropy encoding or entropy decoding progresses. However, [symbol] ŷ [symbol] may always be identical both in the encoder and in the decoder when the same ŷᵢ is processed.

c′″ᵢ may be extracted from \dot{y}. The parameters and entropy models of hₛ may be simply shared both by the encoder and by the decoder.

While training progresses, inputs to entropy models may be noisy representations. The noisy representations may allow the entropy models to approximate the probability mass functions of discrete representations.

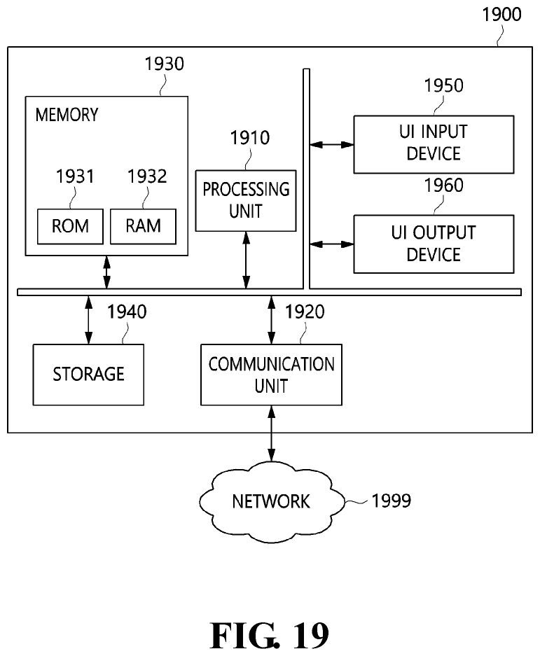

FIG. 19 is a configuration diagram of an encoding apparatus according to an embodiment.

An encoding apparatus 1900 may include a processing unit 1910, memory 1930, a user interface (UI) input device 1950, a UI output device 1960, and storage 1940, which communicate with each other through a bus 1990. The encoding apparatus 1900 may further include a communication unit 1920 coupled to a network 1999.

The processing unit 1910 may be a Central Processing Unit (CPU) or a semiconductor device for executing processing instructions stored in the memory 1930 or the storage 1940. The processing unit 1910 may be at least one hardware processor.

The processing unit 1910 may generate and process signals, data or information that are input to the encoding apparatus 1900, are output from the encoding apparatus 1900, or are used in the encoding apparatus 1900, and may perform examination, comparison, determination, etc. related to the signals, data or information. In other words, in embodiments, the generation and processing of data or information and examination, comparison and determination related to data or information may be performed by the processing unit 1910.

At least some of the components constituting the processing unit 1910 may be program modules, and may communicate with an external device or system. The program modules may be included in the encoding apparatus 1900 in the form of an operating system, an application module, and other program modules.

The program modules may be physically stored in various types of well-known storage devices. Further, at least some of the program modules may also be stored in a remote storage device that is capable of communicating with the encoding apparatus 1900.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the encoding apparatus 1900.

The processing unit 1910 may correspond to the above-described encoder. In other words, the encoding operation that is performed by the encoder, described above with reference to FIG. 17, and by the autoencoder, described above with reference to FIG. 9, may be performed by the processing unit 1910.

The term “storage unit” may denote the memory 1930 and/or the storage 1940. Each of the memory 1930 and the storage 1940 may be any of various types of volatile or nonvolatile storage media. For example, the memory 1930 may include at least one of Read-Only Memory (ROM) 1931 and Random Access Memory (RAM) 1932.

The storage unit may store data or information used for the operation of the encoding apparatus 1900. In an embodiment, the data or information of the encoding apparatus 1900 may be stored in the storage unit.

The encoding apparatus 1900 may be implemented in a computer system including a computer-readable storage medium.

The storage medium may store at least one module required for the operation of the encoding apparatus 1900. The memory 1930 may store at least one module, and may be configured such that the at least one module is executed by the processing unit 1910.

Functions related to communication of the data or information of the encoding apparatus 1900 may be performed through the communication unit 1920.

The network 1999 may provide communication between the encoding apparatus 1900 and a decoding apparatus 1300.

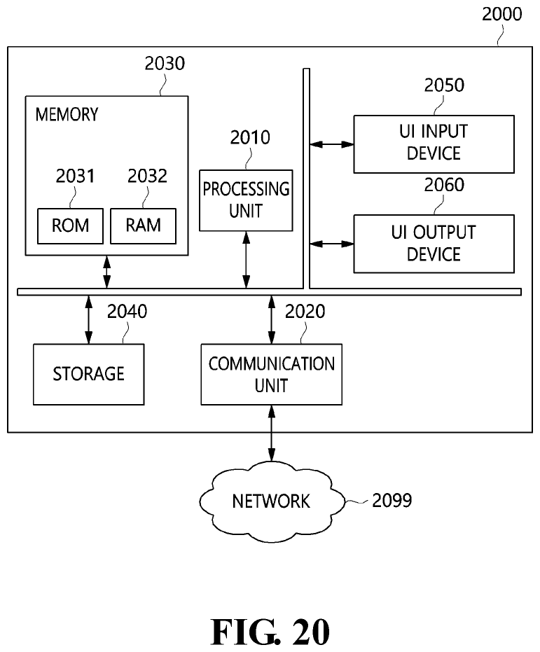

FIG. 20 is a configuration diagram of a decoding apparatus according to an embodiment.

A decoding apparatus 2000 may include a processing unit 2010, memory 2030, a user interface (UI) input device 2050, a UI output device 2060, and storage 2040, which communicate with each other through a bus 2090. The decoding apparatus 2000 may further include a communication unit 2020 coupled to a network 2099.

The processing unit 2010 may be a CPU or a semiconductor device for executing processing instructions stored in the memory 2030 or the storage 2040. The processing unit 2010 may be at least one hardware processor.

The processing unit 2010 may generate and process signals, data or information that are input to the decoding apparatus 2000, are output from the decoding apparatus 2000, or are used in the decoding apparatus 2000, and may perform examination, comparison, determination, etc. related to the signals, data or information. In other words, in embodiments, the generation and processing of data or information and examination, comparison and determination related to data or information may be performed by the processing unit 2010.

At least some of the components constituting the processing unit 2010 may be program modules, and may communicate with an external device or system. The program modules may be included in the decoding apparatus 2000 in the form of an operating system, an application module, and other program modules.

The program modules may be physically stored in various types of well-known storage devices. Further, at least some of the program modules may also be stored in a remote storage device that is capable of communicating with the decoding apparatus 2000.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the decoding apparatus 2000.

The processing unit 2010 may correspond to the above-described decoder. In other words, the decoding operation that is performed by the decoder, described above with reference to FIG. 18, and by the autoencoder, described above with reference to FIG. 9, may be performed by the processing unit 2010.

The term “storage unit” may denote the memory 2030 and/or the storage 2040. Each of the memory 2030 and the storage 2040 may be any of various types of volatile or nonvolatile storage media. For example, the memory 2030 may include at least one of Read-Only Memory (ROM) 2031 and Random Access Memory (RAM) 2032.

The storage unit may store data or information used for the operation of the decoding apparatus 2000. In an embodiment, the data or information of the decoding apparatus 2000 may be stored in the storage unit.

The decoding apparatus 2000 may be implemented in a computer system including a computer-readable storage medium.

The storage medium may store at least one module required for the operation of the decoding apparatus 2000. The memory 2030 may store at least one module, and may be configured such that the at least one module is executed by the processing unit 2010.

Functions related to communication of the data or information of the decoding apparatus 2000 may be performed through the communication unit 2020.

The network 2099 may provide communication between the encoding apparatus 1200 and a decoding apparatus 2000.

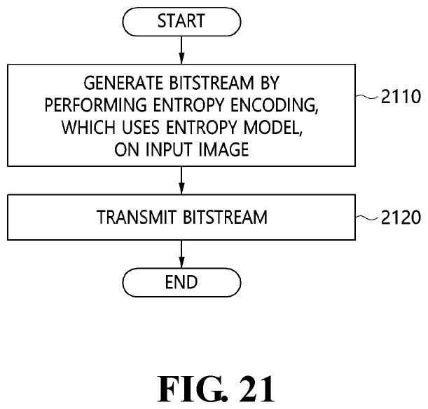

FIG. 21 is a flowchart of an encoding method according to an embodiment.

At step 2110, the processing unit 1910 of the encoding apparatus 1900 may generate a bitstream.

The processing unit 1910 may generate a bitstream by performing entropy encoding, which uses an entropy model, on an input image.

The processing unit 1910 may perform the encoding operation by the encoder, described above with reference to FIG. 17, and the autoencoder, described above with reference to FIG. 9. The processing unit 1910 may use an image compression network and a quality enhancement network when performing encoding.

At step 2120, the communication unit 1920 of the encoding apparatus 1900 may transmit the bitstream. The communication unit 1920 may transmit the bitstream to the decoding apparatus 2000. Alternatively, the bitstream may be stored in the storage unit of the encoding apparatus 1900.

Descriptions of the image entropy encoding and the entropy engine, made in connection with the above-described embodiment, may also be applied to the present embodiment. Repetitive descriptions will be omitted here.

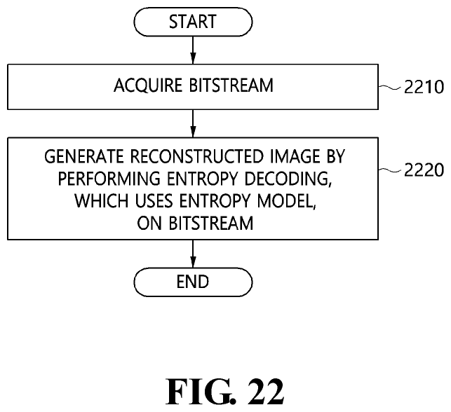

FIG. 22 is a flowchart of a decoding method according to an embodiment.

At step 2210, the communication unit 2020 or the storage unit of the decoding apparatus 2000 may acquire a bitstream.

At step 2220, the processing unit 2010 of the decoding apparatus 2000 may generate a reconstructed image using the bitstream.

The processing unit 2010 of the decoding apparatus 2000 may generate the reconstructed image by performing decoding, which uses an entropy model, on the bitstream.

The processing unit 2010 may perform the decoding operation by the decoder, described above with reference to FIG. 18, and the autoencoder, described above with reference to FIG. 9.

The processing unit 2010 may use an image compression network and a quality enhancement network when performing decoding.

Descriptions of the image entropy decoding and the entropy engine, made in connection with the above-described embodiment, may also be applied to the present embodiment. Repetitive descriptions will be omitted here.

### Padding of Image

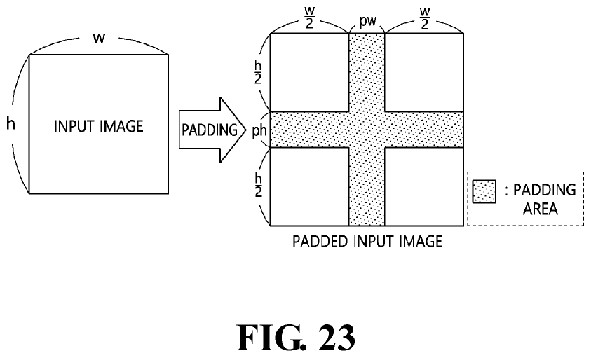

FIG. 23 illustrates padding to an input image according to an example.

In FIG. 23, an example in which, through padding to a central portion of an input image, the size of the input image changes from w×y to w+pw×h+ph is illustrated.

In order to achieve high level multiscale-structural similarity (MS-SSIM), a padding method may be used.

In the image compression method according to the embodiment, ½ down-scaling may be performed at y generation and z generation steps. Therefore, when the size of the input image is a multiple of 2ⁿ, the maximum compression performance may be yielded. Here, n may be the number of down-scaling operations performed on the input image.

For example, in the embodiment described above with reference to FIG. 9, ½ down-scaling from x to y may be performed four times, and ½ down-scaling from y to z may be performed twice. Therefore, it may be preferable for the size of the input image to be a multiple of 2⁶(=64).

Further, in relation to the location of padding, when a specified scheme such as MS-SSIM is used, it is more preferable to perform padding at the center of the input image than padding at the borders of the input image.

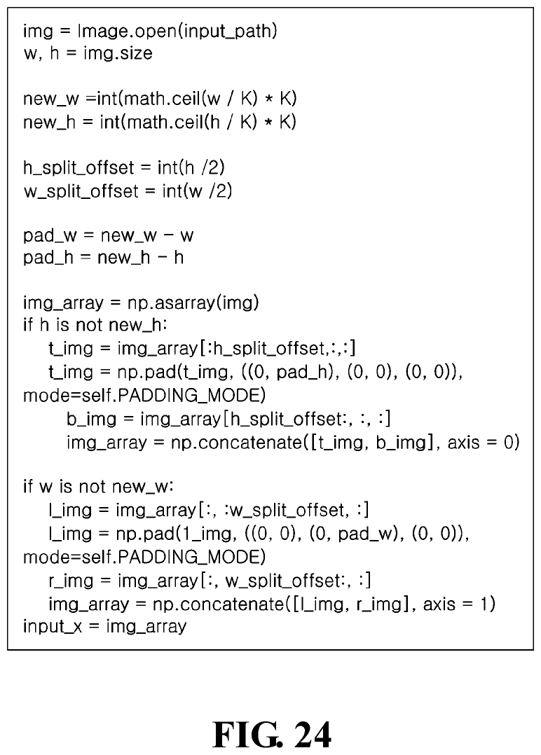

FIG. 24 illustrates code for padding in encoding according to an embodiment.

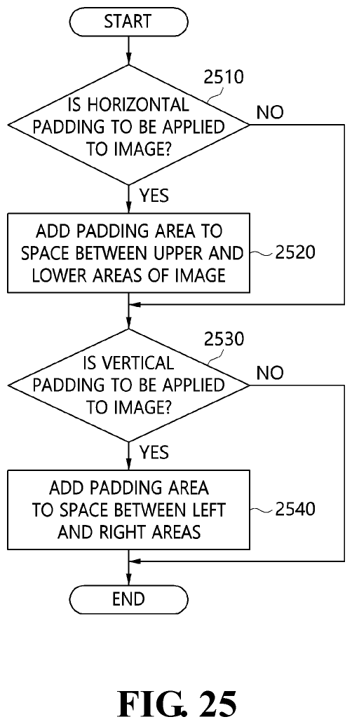

FIG. 25 is a flowchart of a padding method in encoding according to an embodiment.

Step 2110, described above with reference to FIG. 21, may include steps 2510, 2520, 2530, and 2540.

Hereinafter, a reference value k may be 2ⁿ, ‘n’ may be the number of down-scaling operations performed on an input image in an image compression network.

At step 2510, the processing unit 1910 may determine whether horizontal padding is to be applied to the input image.

Horizontal padding may be configured to insert one or more rows into the input image at the center of the vertical axis thereof.

For example, the processing unit 1910 may determine, based on the height h of the input image and the reference value k, whether horizontal padding is to be applied to the input image. When the height h of the input image is not a multiple of the reference value k, the processing unit 1910 may apply horizontal padding to the input image. When the height h of the input image is a multiple of the reference value k, the processing unit 1910 may not apply horizontal padding to the input image

When it is determined that the horizontal padding is to be applied to the input image, step 2520 may be performed.

When it is determined that the horizontal padding is not to be applied to the input image, step 2530 may be performed.

At step 2520, the processing unit 1910 may apply horizontal padding to the input image. The processing unit 1910 may add a padding area to a space between an upper area and a lower area of the input image.

The processing unit 1910 may adjust the height of the input image so that the height is a multiple of the reference value k by applying the horizontal padding to the input image.

For example, the processing unit 1910 may generate an upper image and a lower image by splitting the input image in a vertical direction. The processing unit 1910 may apply padding between the upper image and the lower image. The processing unit 1910 may generate a padding area. The processing unit 1910 may generate an input image, the height of which is adjusted, by combining the upper image, the padding area, and the lower image.

Here, padding may be edge padding.

At step 2530, the processing unit 1910 may determine whether vertical padding is to be applied to the input image.

Vertical padding may be configured to insert one or more columns into the input image at the center of the horizontal axis thereof.

For example, the processing unit 1910 may determine, based on the width (area) w of the input image and the reference value k, whether vertical padding is to be applied to the input image. When the width w of the input image is not a multiple of the reference value k, the processing unit 1910 may apply vertical padding to the input image. When the width w of the input image is a multiple of the reference value k, the processing unit 1910 may not apply vertical padding to the input image.

When it is determined that vertical padding is to be applied to the input image, step 2540 may be performed.

When it is determined that vertical padding is not to be applied to the input image, the process may be terminated.

At step 2540, the processing unit 1910 may apply vertical padding to the input image. The processing unit 1910 may add a padding area to the space between a left area and a right area of the input image.

The processing unit 1910 may adjust the width of the input image so that the width is a multiple of the reference value k by applying the vertical padding to the input image.

For example, the processing unit 1910 may generate a left image and a right image by splitting the input image in a vertical direction. The processing unit 1910 may apply padding to a space between the left image and the right image. The processing unit 1910 may generate a padding area. The processing unit 1910 may generate an input image, the width of which is adjusted, by combining the left image, the padding area, and the right image.

Here, the padding may be edge padding.

By means of padding at the above-described steps 2510, 2520, 2530, and 2540, a padded image may be generated. Each of the width and height of the padded image may be a multiple of the reference value k.

The padded image may be used to replace the input image.

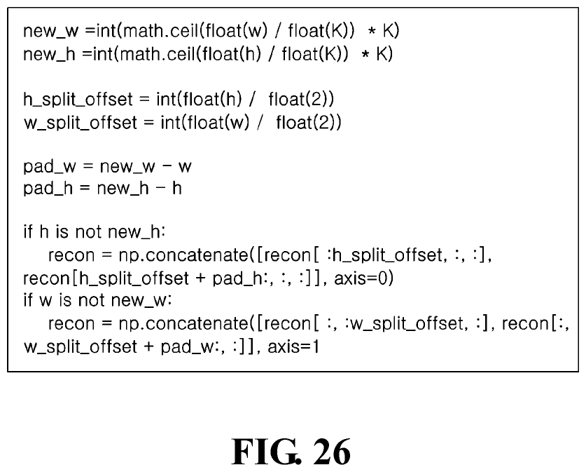

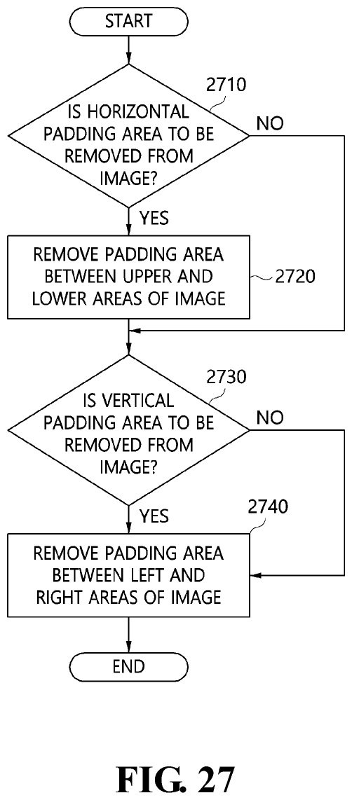

FIG. 26 illustrates code for removing a padding area in encoding according to an embodiment.

FIG. 27 is a flowchart of a padding removal method in encoding according to an embodiment.

Step 2220, described above with reference to FIG. 22, may include steps 2710, 2720, 2730, and 2740.

Hereinafter, a target image may be an image reconstructed for the image to which padding is applied in the embodiment described above with reference to FIG. 25. In other words, the target image may be an image generated by performing padding, encoding, and decoding on the input image. Hereinafter, the height h of the original image may be the height of the input image before horizontal padding is applied. The width w of the original image may be the width of the input image before vertical padding is applied.

Hereinafter, a reference value k may be 2ⁿ. ‘n’ may be the number of down-scaling operations performed on the input image in an image compression network.

At step 2710, the processing unit 2010 may determine whether a horizontal padding area is to be removed from the target image.

The removal of the horizontal padding area may be configured to remove one or more rows from the target image at the center of the vertical axis thereof.

For example, the processing unit 2010 may determine whether a horizontal padding area is to be removed from the target image based on the height h of the original image and the reference value k. When the height h of the original image is not a multiple of the reference value k, the processing unit 2010 may remove the horizontal padding area from the target image. When the height h of the original image is a multiple of the reference value k, the processing unit 2010 may not remove the horizontal padding area from the target image.

For example, the processing unit 2010 may determine whether a horizontal padding area is to be removed from the target image based on the height h of the original image and the height of the target image. When the height h of the original image is not equal to the height of the target image, the processing unit 2010 may remove the horizontal padding area from the target image. When the height h of the original image is equal to the height of the target image, the processing unit 2010 may not remove the horizontal padding area from the target image.

When it is determined that the horizontal padding area is to be removed from the target image, step 2720 may be performed.

When it is determined that the horizontal padding area is not to be removed from the target image, step 2730 may be performed.

At step 2720, the processing unit 2010 may remove the horizontal padding area from the target image The processing unit 2010 may remove a padding area between the upper area of the target image and the lower area of the input image.

For example, the processing unit 2010 may generate an upper image and a lower image by removing the horizontal padding area from the target image. The processing unit 2010 may adjust the height of the target image by combining the upper image with the lower image.

Through the removal of the padding area, the height of the target image may be equal to the height h of the original image.

Here, the padding area may be an area generated by edge padding.

At step 2730, the processing unit 2010 may determine whether a vertical padding area is to be removed from the target image.

The removal of the vertical padding area may be configured to remove one or more columns from the target image at the center of the horizontal axis thereof.

For example, the processing unit 2010 may determine whether a vertical padding area is to be removed from the target image based on the area (width) w of the original image and the reference value k. When the width w of the original image is not a multiple of the reference value k, the processing unit 2010 may remove the vertical padding area from the target image. When the width w of the original image is a multiple of the reference value k, the processing unit 2010 may not remove the vertical padding area from the target image.

For example, the processing unit 2010 may determine whether a vertical padding area is to be removed from the target image based on the area (width) w of the original image and the area (width) of the target image. When the width w of the original image is not equal to the width of the target image, the processing unit 2010 may remove the vertical padding area from the target image. When the width w of the original image is equal to the width of the target image, the processing unit 2010 may not remove the vertical padding area from the target image.

When it is determined that the vertical padding area is to be removed from the target image, step 2740 may be performed.

When it is determined that the vertical padding area is not to be removed from the target image, the process may be terminated.

At step 2740, the processing unit 2010 may remove the vertical padding area from the target image. The processing unit 2010 may remove the padding area between the left area of the target image and the right area of the input image.

For example, the processing unit 2010 may generate a left image and a right image by removing the vertical padding area from the target image. The processing unit 2010 may adjust the width of the target image by combining the left image with the right image.

Here, the padding area may be an area generated by edge padding.

The padding areas may be removed from the target image at steps 2710, 2720, 2730 and 2740.

The apparatus described above may be implemented through hardware components, software components, and/or combinations thereof. For example, the apparatus, method and components described in the embodiments may be implemented using one or more general-purpose computers or special-purpose computers, for example, a processor, a controller, an arithmetic logic unit (ALU), a digital signal processor, a microcomputer, a field-programmable gate array (FPGA), a programmable logic unit (PLU), a microprocessor, or any other device capable of executing instructions and responding thereto, A processing device may run an operating system (OS) and one or more software applications executed on the OS. Also, the processing device may access, store, manipulate, process and create data in response to execution of the software. For the convenience of description, the processing device is described as a single device, but those having ordinary skill in the art will understand that the processing device may include multiple processing elements and/or multiple forms of processing elements. For example, the processing device may include multiple processors or a single processor and a single controller. Also, other processing configurations such as parallel processors may be available.

The software may include a computer program, code, instructions, or a combination thereof, and may configure a processing device to be operated as desired, or may independently or collectively instruct the processing device to be operated. The software and/or data may be permanently or temporarily embodied in a specific form of machines, components, physical equipment, virtual equipment, computer storage media or devices, or transmitted signal waves in order to be interpreted by a processing device or to provide instructions or data to the processing device. The software may be distributed across computer systems connected with each other via a network, and may be stored or run in a distributed manner. The software and data may be stored in one or more computer-readable storage media.

The method according to the embodiments may be implemented in the form of program instructions that are executable by various types of computer means, and may be stored in a computer-readable storage medium.

The computer-readable storage medium may include information used in embodiments according to the present disclosure. For example, the computer-readable storage medium may include a bitstream, which may include various types of information described in the embodiments of the present disclosure.

The computer-readable storage medium may include a non-transitory computer-readable medium.

The computer-readable storage medium may individually or collectively include program instructions, data files, data structures, and the like. The program instructions recorded in the media may be specially designed and configured for the embodiment, or may be readily available and well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine language code made by a compiler but also high-level language code executable by a computer using an interpreter or the like. The above-mentioned hardware device may be configured so as to operate as one or more software modules in order to perform the operations of the embodiment and vice-versa.

Although the present disclosure has been described above with reference to a limited number of embodiments and drawings, those skilled in the art will appreciate that various changes and modifications are possible from the descriptions. For example, even if the above-described technologies are performed in a sequence other than those of the described methods and/or when the above-described components, such as systems, structures, devices, and circuits, are coupled or combined in forms other than those in the described methods or are replaced or substituted by other components or equivalents, suitable results may be achieved.

The apparatus described in the embodiments may include one or more processors, and may also include memory. The memory may store one or more programs that are executed by the one or more processors. The one or more programs may perform the operations of the apparatus described in the embodiment. For example, the one or more programs of the apparatus may perform operations described at steps related to the apparatus, among the above-described steps. In other words, the operations of the apparatus described in the embodiments may be executed by the one or more programs. The one or more programs may include a program, an application, an APP, etc. of the apparatus described above in the embodiment. For example, any one of the one or more programs may correspond to the program, the application, and the APP of the apparatus described above in the embodiments.

1. An encoding method, comprising:
generating a bitstream by performing entropy encoding that uses an entropy model on an input image; and
transmitting or storing the bitstream.

2. The encoding method of claim 1, wherein:
the entropy model is a context-adaptive entropy model, and
the context-adaptive entropy model exploits three different types of contexts.

3. The encoding method of claim 2, wherein the contexts are used to estimate parameters of a Gaussian mixture model.

4. The encoding method of claim 3, wherein the parameters include a weight parameter, a mean parameter, and a standard deviation parameter.

5. The encoding method of claim 1, wherein:
the entropy model is a context-adaptive entropy model, and
the context-adaptive entropy model uses a global context.

6. The encoding method of claim 1, wherein the entropy encoding is performed by combining an image compression network with a quality enhancement network.

7. The encoding method of claim 6, wherein the quality enhancement network is a very deep super resolution network (VDSR), a residual dense network (RDN) or a grouped residual dense Network (GRDN).

8. The encoding method of claim 1, wherein:
horizontal padding or vertical padding is applied to the input image,
the horizontal padding is to insert one or more rows into the input image at a center of a vertical axis thereof, and
the vertical padding is to insert one or more columns into the input image at a center of a horizontal axis thereof.

9. The encoding method of claim 8, wherein:
the horizontal padding is performed when a height of the input image is not a multiple of k,
the vertical padding is performed when a width of the input image is not a multiple of k,
k is 2ⁿ, and
n is a number of down-scaling operations performed on the input image.

10. A storage medium storing the bitstream generated by the encoding method of claim 1.

11. A decoding apparatus, comprising:
a communication unit for acquiring a bitstream; and
a processing unit for generating a reconstructed image by performing decoding that uses an entropy model on the bitstream.

12. A decoding method, comprising:
acquiring a bitstream; and
generating a reconstructed image by performing decoding that uses an entropy model on the bitstream.

13. The decoding method of claim 12, wherein:
the entropy model is a context-adaptive entropy model, and
the context-adaptive entropy model exploits three different types of contexts.

14. The decoding method of claim 13, wherein the contexts are used to estimate parameters of a Gaussian mixture model.

15. The decoding method of claim 14, wherein the parameters include a weight parameter, a mean parameter, and a standard deviation parameter.

16. The decoding method of claim 12, wherein:
the entropy model is a context-adaptive entropy model, and
the context-adaptive entropy model uses a global context.

17. The decoding method of claim 12, wherein:
the entropy decoding is performed by combining an image compression network with a quality enhancement network.

18. The decoding method of claim 12, wherein the quality enhancement network is a very deep super resolution network (VDSR), a residual dense network (RDN) or a grouped residual dense Network (GRDN).

19. The decoding method of claim 12, wherein:
a horizontal padding area or a vertical padding area is removed from the reconstructed image,
removal of the horizontal padding area is to remove one or more rows from the reconstructed image at a center of a vertical axis thereof, and
removal of the vertical padding area is to remove one or more columns from the reconstructed image at a center of a horizontal axis thereof.

20. The decoding method of claim 19, wherein:
the removal of the horizontal padding area is performed when a height of an original image is not a multiple of k,
the removal of the vertical padding area is performed when a width of the original image is not a multiple of k,
k is 2ⁿ, and
n is a number of down-scaling operations performed on the original image.
